(19) United States
(12) Patent Application Publication
(10) Pub. No.: US 2005/0061182 A1
(43) Pub. Date: Mar. 24, 2005

(54) Method and apparatus for cleaning printing press

(76) Inventors: Toshihiko Ebina, Ibaraki (JP); Kazunori Nagaki, Ibaraki (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/943,281

(22) Filed: Sep. 17, 2004

(30) Foreign Application Priority Data
Sep. 19, 2003 (JP) 328902/2003

(51) Int. Cl. B41F 35/00; B41L 41/00

(52) U.S. Cl. 101/425

(57) ABSTRACT

In a printing press cleaning method of cleaning a circumferential surface of a rotary member on the basis of a cleaning parameter, the cleaning parameter is displayed. The displayed cleaning parameter is changed. The rotary member is cleaned on the basis of the changed cleaning parameter. The cleaning parameter includes at least one of values related to a cleaning member which comes into contact with the rotary member, a cleaning solution which is supplied to the rotary member, and the rotary member. A printing press cleaning apparatus is also disclosed.

### BACKGROUND OF THE INVENTION

The present invention relates to a method and apparatus for cleaning a printing press, which clean rotary members (e.g., a blanket cylinder, impression cylinder, transfer cylinder, plate cylinder, and rollers of an inking device) in a printing press.

Conventionally, when a rotary member in a printing press, and for example, a blanket cylinder is to be cleaned, a cleaning solution is sprayed to a cleaning web, and the cleaning web dampened with the cleaning solution is brought into contact with the rotating blanket cylinder. When the cleaning web is contaminated at the portion in contact with the blanket cylinder, the cleaning web is separated from the blanket cylinder. The dirty portion of the cleaning web is wound up. Then, a clean portion of the cleaning web is brought into contact with the blanket cylinder (U.S. Pat. No. 4,344,361). In this case, the contact ON/OFF time and the contact ON/OFF count of the cleaning web to the blanket cylinder and the discharge time of the cleaning solution to the cleaning web are determined in advance as cleaning parameters.

However, in the conventional printing press cleaning method, the cleaning parameters such as the contact ON/OFF time and the contact ON/OFF count of the cleaning web to the blanket cylinder and the discharge time of the cleaning solution to the cleaning web are fixed. If a cleaning condition (e.g., the degree of contamination on the blanket cylinder, the material of the cleaning web, or the component of the cleaning solution) changes, no appropriate cleaning effect can be obtained in some cases by the fixed cleaning parameters. More specifically, hard contamination on the blanket cylinder cannot completely be removed with the fixed cleaning parameters. The blanket cylinder must be cleaned again. If the contamination is light, the cleaning solution or cleaning web is wasted.

### SUMMARY OF THE INVENTION

It is an object of the present invention to provide a method and apparatus for cleaning a printing press, which allow an operator to appropriately change cleaning parameters.

In order to achieve the above object, according to the present invention, there is provided a printing press cleaning method of cleaning a circumferential surface of a rotary member on the basis of a cleaning parameter, comprising the steps of displaying the cleaning parameter, changing the displayed cleaning parameter, and cleaning the rotary member on the basis of the changed cleaning parameter, wherein the cleaning parameter includes at least one of values related to a cleaning member which comes into contact with the rotary member, a cleaning solution which is supplied to the rotary member, and the rotary member.

### BRIEF DESCRIPTION OF THE DRAWINGS

FIG. 1 is a schematic view showing the arrangement of a four-color sheet-fed offset printing press according to an embodiment of the present invention;

FIGS. 2A and 2B are side views of a cleaning apparatus which cleans the surface of a blanket cylinder shown in FIG. 1;

FIG. 3 is a front sectional view showing the attached state of a winding roll included in the cleaning apparatus shown in FIGS. 2A and 2B;

FIG. 4A is a view of a shaft 6n in FIG. 3 when viewed from a direction A;

FIG. 4B is a view of a shaft 60 viewed from a direction B;

FIG. 5 is a side view of the cleaning apparatus when the outer diameter of the winding roll has increased;

FIG. 6 is a block diagram of a printing press control apparatus which controls the four-color sheet-fed offset printing press shown in FIG. 1;

FIG. 7 is a schematic view showing an arrangement to discharge a solvent and water from the cleaning nozzle of the cleaning apparatus;

FIG. 8 is a timing chart of the cleaning work according to “cleaning pattern 1”;

FIG. 9 is a timing chart of the cleaning work according to “cleaning pattern 2”;

FIG. 10 is a timing chart of the cleaning work according to “cleaning pattern 3”;

FIG. 11 is a timing chart of the cleaning work according to “cleaning pattern 4”;

FIG. 12 is a view showing setting examples and setting ranges of cleaning parameters set in “cleaning pattern 1”;

FIG. 13 is a view showing setting examples and setting ranges of cleaning parameters set in “cleaning pattern 2”;

FIG. 14 is a view showing setting examples and setting ranges of cleaning parameters set in “cleaning pattern 3”;

FIG. 15 is a view showing setting examples and setting ranges of cleaning parameters set in “cleaning pattern 4”;

FIG. 16 is a flowchart of the cleaning work executed by the printing press control apparatus shown in FIG. 6;

FIG. 17 is a flowchart showing “cleaning process” in the cleaning work executed by the printing press control apparatus shown in FIG. 6;

FIG. 18 is a flowchart showing “solvent discharge process” in the cleaning work executed by the printing press control apparatus shown in FIG. 6;

FIG. 19 is a flowchart showing “water discharge process” in the cleaning work executed by the printing press control apparatus shown in FIG. 6;

FIG. 20 is a flowchart showing “cloth feed 1 process” in the cleaning work executed by the printing press control apparatus shown in FIG. 6;

FIG. 21 is a flowchart showing “cloth feed 2 process” in the cleaning work executed by the printing press control apparatus shown in FIG. 6;

FIG. 22 is a flowchart showing “cloth feed 3 process” in the cleaning work executed by the printing press control apparatus shown in FIG. 6;

FIG. 23 is a flowchart showing “cloth feed 4 process” in the cleaning work executed by the printing press control apparatus shown in FIG. 6;

FIG. 24 is a block diagram of a central control apparatus shown in FIG. 6;

FIG. 25 is a view showing a cleaning parameter change operation window displayed on the display of the central control apparatus shown in FIG. 24;

FIG. 26 is a flowchart of a cleaning parameter change process executed by the central control apparatus shown in FIG. 24;

FIG. 27 is a flowchart showing the first process in the cleaning parameter change process executed by the central control apparatus shown in FIG. 24;

FIG. 28 is a flowchart showing the second process in the cleaning parameter change process executed by the central control apparatus shown in FIG. 24;

FIG. 29 is a flowchart showing the third process in the cleaning parameter change process executed by the central control apparatus shown in FIG. 24;

FIG. 30 is a flowchart showing the fourth process in the cleaning parameter change process executed by the central control apparatus shown in FIG. 24;

FIG. 31 is a flowchart showing the fifth process in the cleaning parameter change process executed by the central control apparatus shown in FIG. 24;

FIG. 32 is a flowchart showing the sixth process in the cleaning parameter change process executed by the central control apparatus shown in FIG. 24;

FIG. 33 is a flowchart showing the seventh process in the cleaning parameter change process executed by the central control apparatus shown in FIG. 24;

FIG. 34 is a flowchart showing the eighth process in the cleaning parameter change process executed by the central control apparatus shown in FIG. 24;

FIG. 35 is a flowchart showing the ninth process in the cleaning parameter change process executed by the central control apparatus shown in FIG. 24;

FIG. 36 is a flowchart showing the 10th process in the cleaning parameter change process executed by the central control apparatus shown in FIG. 24;

FIG. 37 is a flowchart showing the 11th process in the cleaning parameter change process executed by the central control apparatus shown in FIG. 24;

FIG. 38 is a flowchart showing the 12th process in the cleaning parameter change process executed by the central control apparatus shown in FIG. 24;

FIG. 39 is a flowchart showing the 13th process in the cleaning parameter change process executed by the central control apparatus shown in FIG. 24;

FIG. 40 is a flowchart showing the 14th process in the cleaning parameter change process executed by the central control apparatus shown in FIG. 24;

FIG. 41 is a flowchart showing the 15th process in the cleaning parameter change process executed by the central control apparatus shown in FIG. 24;

FIG. 42 is a view showing the cleaning parameter change operation window in which the user can arbitrarily set the solvent discharge time for the first time and that from the second time;

FIG. 43 is a block diagram of the printing press control apparatus in the example in which the user can arbitrarily set the solvent discharge time for the first time and that from the second time;

FIG. 44 is a block diagram of the central control apparatus in the example in which the user can arbitrarily set the solvent discharge time for the first time and that from the second time; and

FIG. 45 is a flowchart of “solvent discharge process” executed by the printing press control apparatus in the example in which the user can arbitrarily set the solvent discharge time for the first time and that from the second time.

### DESCRIPTION OF THE PREFERRED EMBODIMENT

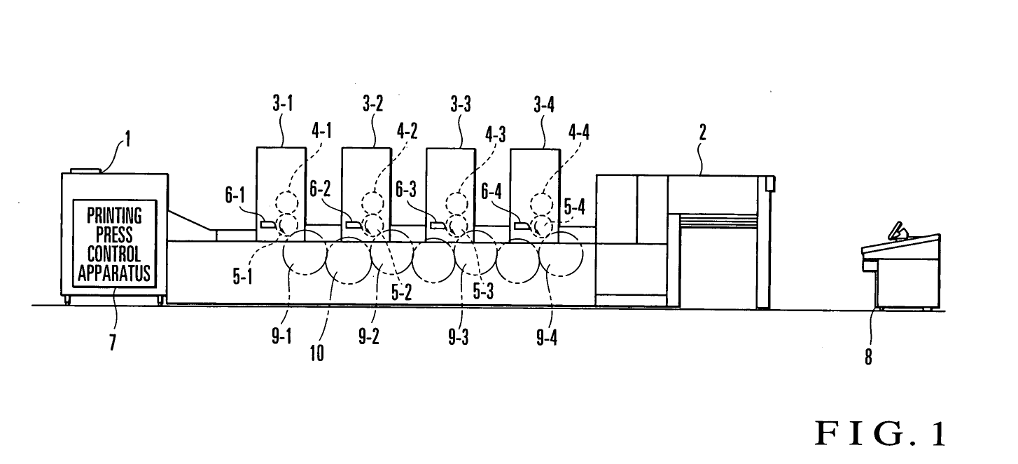

The present invention will be described below in detail with reference to the accompanying drawings. A four-color sheet-fed offset printing press shown in FIG. 1 comprises a feeder 1 which feeds printing paper sheet, a delivery unit 2 which delivers printed paper sheet, and first to fourth-color printing units 3-1 to 3-4 which are located between the feeder 1 and the delivery unit 2.

The printing units 3-1 to 3-4 comprise plate cylinders 4-1 to 4-4, blanket cylinders 5-1 to 5-4, and impression cylinders 9-1 to 9-4. Printing plates are mounted on the plate cylinders 4-1 to 4-4. Inks from the printing plates mounted on the plate cylinders 4-1 to 4-4 are transferred to the blanket cylinders 5-1 to 5-4. The impression cylinders 9-1 to 9-4 hold and convey a sheet-shaped object and transfer the inks on the blanket cylinders 5-1 to 5-4 to the sheet-shaped object. The printing units 3-1 to 3-4 also comprise cleaning apparatuses 6-1 to 6-4. The cleaning apparatuses 6-1 to 6-4 clean the circumferential surfaces of the blanket cylinders 5-1 to 5-4, respectively.

The four-color sheet-fed offset printing press has a control apparatus (printing press control apparatus) 7 and a central control apparatus 8. The control apparatus 7 controls the operation of the printing press including the cleaning work (cleaning+drying) of a blanket cylinder 5 by using a cleaning apparatus 6. The central control apparatus 8 is connected to the control apparatus 7 through a wireless or cable communication means. Although not illustrated, each printing unit 3 has rollers of an inking device, rollers of a dampening unit, and an automatic impression cylinder cleaner. The inking device supplies ink to the printing plate mounted on a plate cylinder 4. The dampening unit supplies water to the printing plate. The automatic impression cylinder cleaner cleans the upper surface of an impression cylinder 9. Transfer cylinders 10 are arranged between the impression cylinders 9 of the color printing units.

[Cleaning Apparatus]

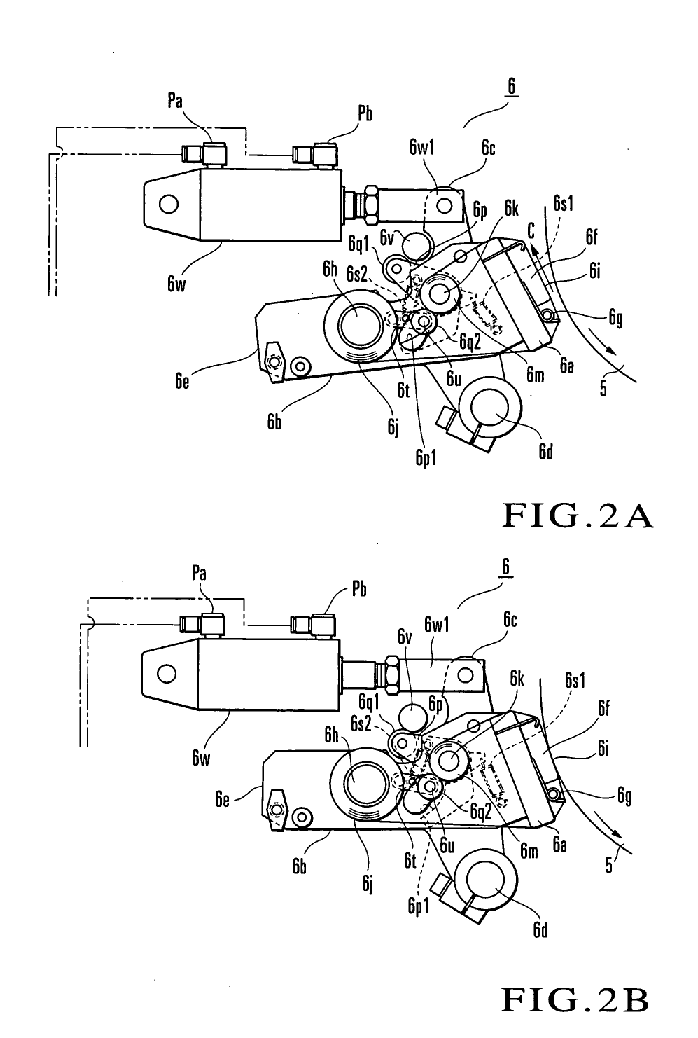

FIG. 2A shows a state in which a cleaning web is separated from the blanket cylinder. FIG. 2B shows a state in which the cleaning web is in contact with the blanket cylinder. The cleaning apparatus 6 is arranged in front of the blanket cylinder 5. The cleaning apparatus 6 comprises a pair of left and right unit frames 6b (one of them is not shown) attached to a stay 6a to be parallel to each other. A lower end portion of a driving lever 6c is fixed to a shaft 6d which is rotatably supported between the frames. A cleaning unit 6e including the stay 6a and the left and right unit frames 6b is detachably fixed to the driving lever 6c.

A cleaning pad 6f having almost the same width as the blanket cylinder 5 and a “U”-shaped section is attached to the stay 6a to be almost parallel to the blanket cylinder 5. The stay 6a also has a cleaning nozzle 6g which discharges a solvent and water. A supply roll 6j including a cylindrical core (supply shaft) 6h and a cleaning cloth 6i serving as a cleaning web which is wound on the core 6h in a separate step is rotatably and detachably axially supported at almost the central portion between the left and right unit frames 6b. A winding roll 6m including a cylindrical core (winding shaft) 6k and the cleaning cloth 6i wound on the core 6k is rotatably and detachably axially supported on the side of the blanket cylinder 5 between the left and right unit frames 6b.

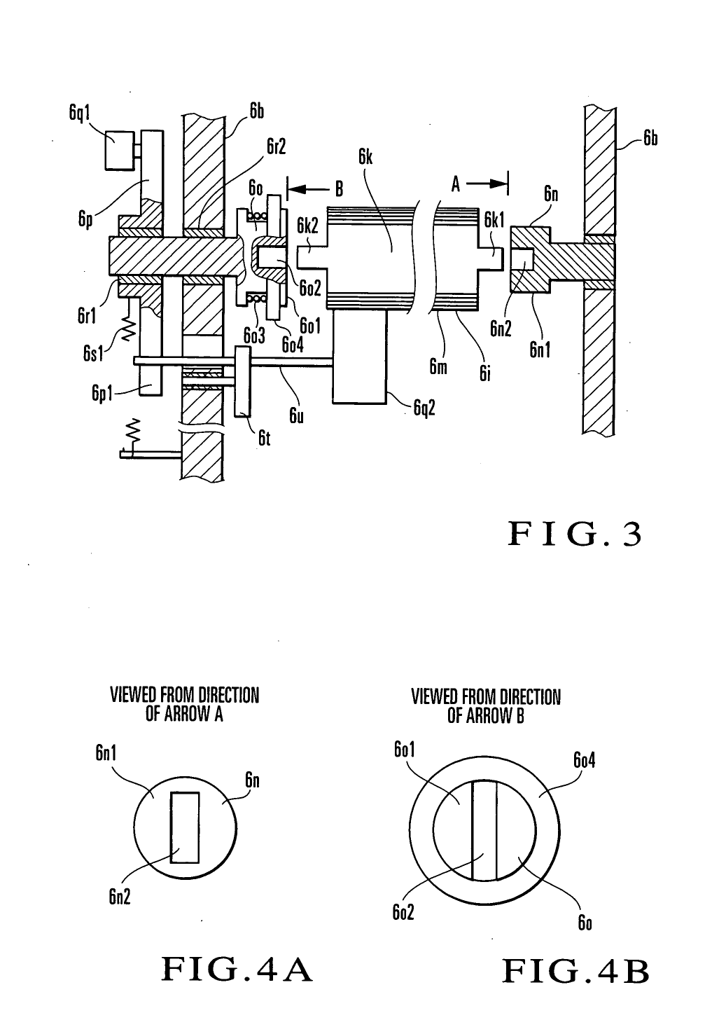

Referring to FIG. 3, the right unit frame 6b has a shaft 6n in which a convex portion 6k1 projecting from one end of the winding shaft 6k is fitted. The left unit frame 6b has a shaft 60 in which a convex portion 6k2 projecting from the other end of the winding shaft 6k is fitted. The shaft 6n is pivotally axially supported by the right unit frame 6b. The shaft 60 is pivotally axially supported by the left unit frame 6b.

FIG. 4A shows the shaft 6n viewed from a direction A. FIG. 4B shows the shaft 60 viewed from a direction B. The shaft 6n has a concave portion 6n2 at a head portion 6n1. The convex portion 6k1 of the winding shaft 6k is fitted in the concave portion 6n2. The shaft 60 has a groove 602 at a head portion 601. In addition, a ring 604 is fitted around the head portion 601. The ring 604 is pressed and biased to the flange surface of the head portion 601 by a spring 603. The convex portion 6k2 of the winding shaft 6k is inserted to the groove 602 while retracting the ring 604 against the spring 603. Then, the ring 604 is released from the hand. The ring 604 is returned to its home position by the restoring force of the spring 603 so that the convex portion 6k2 is locked in the groove 602.

A cleaning cloth winding lever 6p is made of a V-shaped flat plate. A wheel 6q1 is pivotally mounted at one end of the lever 6p. The central portion of the lever 6p is coupled to the end portion of the shaft 60 through a one-way clutch 6r1. The central portion of the lever 6p is biased clockwise in FIGS. 2A and 2B by a spring 6s1 by using the shaft 60 as a pivot center. The shaft 60 is supported by the left unit frame 6b through a one-way clutch 6r2.

A wheel 6q2 is pivotally mounted at one end of a fixed amount feed lever 6t through a shaft 6u. The other end of the lever 6t is pivotally axially supported by the unit frame 6b. A spring 6s2 is hooked between the lever 6t and the lever 6p such that the wheel 6q2 pivotally amounted on the lever 6t is pressed against the cleaning cloth 6i on the winding roll 6m. The wheel 6q2 is pivotally mounted on the lever 6t through the shaft 6u. The end portion of the shaft 6u extends through the unit frame 6b and engages with a cam face 6p1 of the lever 6p.

A pin 6v which actuates a lever for winding up the cleaning cloth stands upward on the frame. Reference numeral 6w denotes a pneumatic cylinder. An actuating rod 6w1 of the pneumatic cylinder 6w is pivotally mounted at the upper end portion of the driving lever 6c. The pneumatic cylinder 6w has two ports Pa and Pb. When compressed air is fed to the port Pa, the actuating rod 6w1 moves forward. When compressed air is fed to the port Pb, the actuating rod 6w1 moves back.

In the state shown in FIG. 2A, when the actuating rod 6w1 moves forward, the driving lever 6c pivots clockwise about the shaft 6d. The cleaning unit 6e moves to the side of the blanket cylinder 5. As shown in FIG. 2B, the cleaning cloth 6i is pressed against the surface of the blanket cylinder 5 by the cleaning pad 6f. When the actuating rod 6w1 moves forward, in the cleaning unit 6e, the wheel 6q1 hits the pin 6v to make the lever 6p pivot counterclockwise. Accordingly, the winding shaft 6k pivots counterclockwise and winds up the cleaning cloth 6i.

In the state shown in FIG. 2B, when the actuating rod 6w1 moves back, the driving lever 6c pivots counterclockwise about the shaft 6d. As shown in FIG. 2A, the cleaning cloth 6i separates from the surface of the blanket cylinder 5. When the actuating rod 6w1 moves back, in the cleaning unit 6e, the lever 6p is caused to pivot clockwise by the biasing force of the spring 6s1. Accordingly, the wheel 6q1 returns to its home position, and a gap is formed between the wheel 6q1 and the pin 6v. In this case, as shown in FIG. 3, the clockwise pivotal movement of the winding shaft 6k is regulated because the one-way clutches 6r are inserted between the lever 6p and the shaft 60 and between the unit frame 6b and the shaft 60. Hence, the cleaning cloth 6i is never rewound from the winding roll 6m.

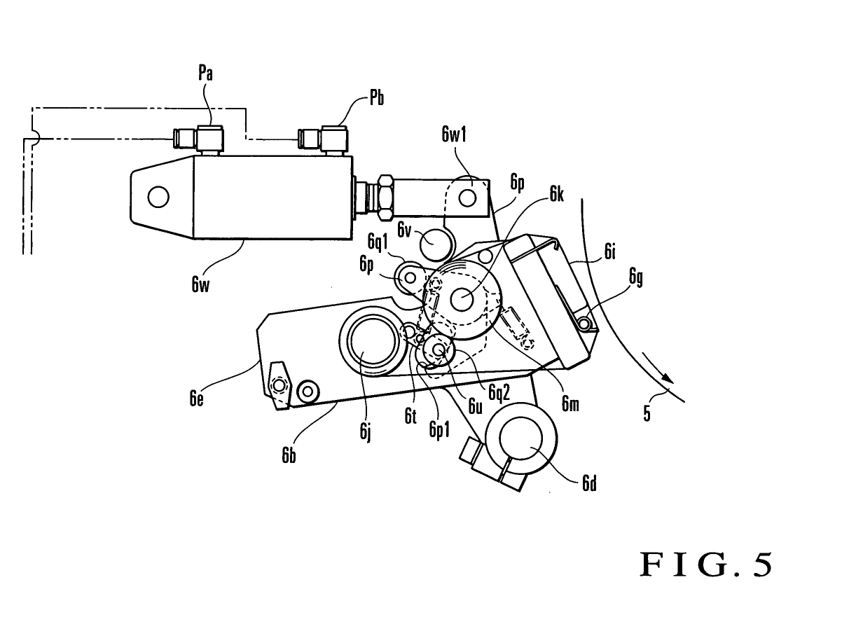

The outer diameter of the winding roll 6m increases as it winds up the cleaning cloth 6i. FIG. 5 shows a state in which the outer diameter of the winding roll 6m has increased. When the outer diameter of the winding roll 6m increases, the wheel 6q2 pressed against the cleaning cloth 6i wound on the winding shaft 6k moves downward, and the lever 6t pivots clockwise. Accordingly, the engagement position between the end portion of the shaft 6u and the cam face 6p1 of the lever 6p changes. The opposing interval between the pin 6v and the wheel 6q1 pivotally mounted on the lever 6p increases. As a result, the pivotal angle of the lever 6p by one forward movement of the actuating rod 6w1 is regulated in accordance with the outer diameter of the winding roll 6m. Hence, the winding amount of the cleaning cloth 6i wound on the winding shaft 6k, i.e., the feed amount of the cleaning cloth 6i is always constant independently of the outer diameter of the winding roll 6m.

In this embodiment, the cleaning nozzle 6g is arranged on the lower side upstream the moving direction of the cleaning cloth 6i with respect to the contact portion where the cleaning cloth 6i and blanket cylinder 5 come into contact. With this arrangement, the solvent or water from the cleaning nozzle 6g is discharged to the cloth surface located on the lower side of the contact portion between the cleaning cloth 6i and the blanket cylinder 5 and penetrates from that cloth surface. In this embodiment, the cleaning cloth 6i moves in a direction indicated by an arrow C (upward) in FIG. 2A.

(Printing Press Control Apparatus)

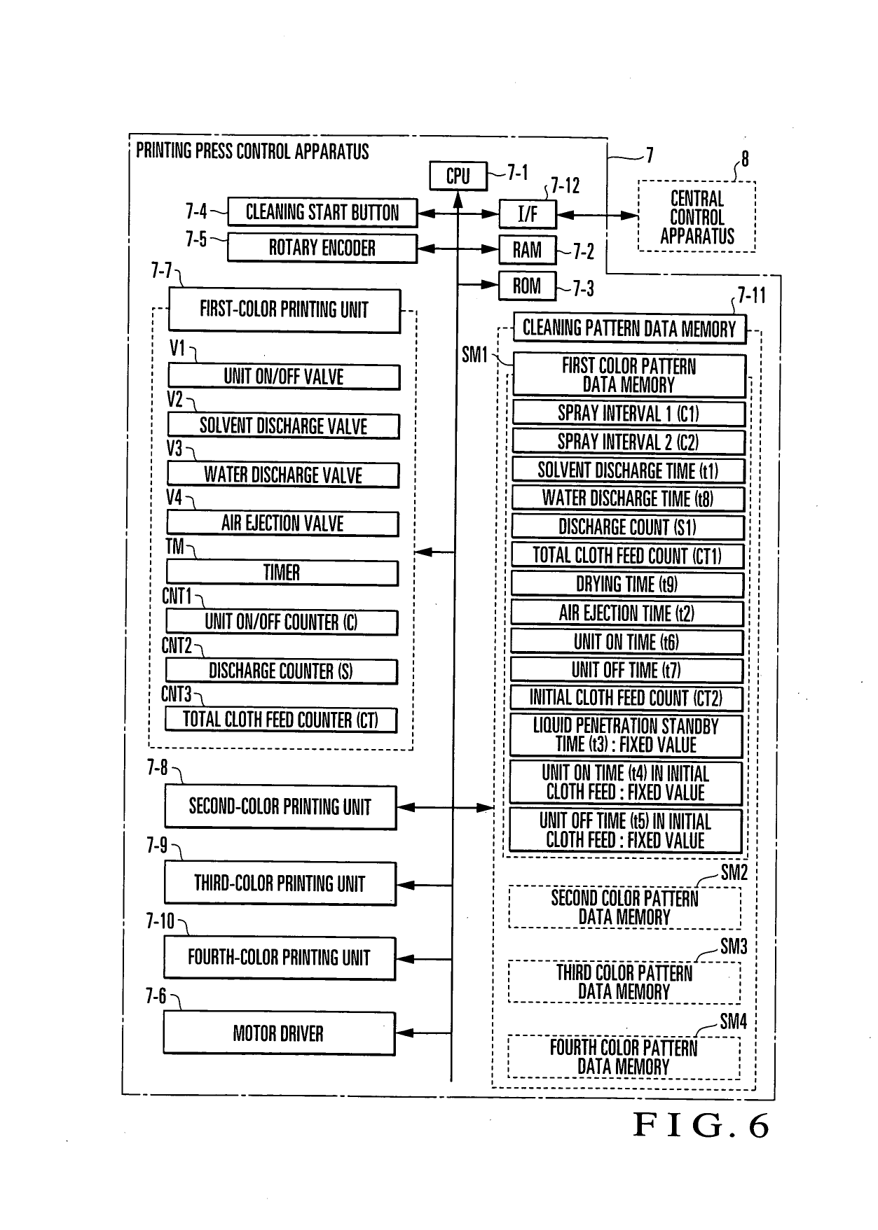

Referring to FIG. 6, the printing press control apparatus 7 comprises a CPU (Central Processing Unit) 7-1, RAM (Random Access Memory) 7-2, ROM (Read Only Memory) 7-3, cleaning start button 7-4, rotary encoder 7-5, motor driver 7-6, constituent elements 7-7, 7-8, 7-9, and 7-10, unit ON/OFF valve V1, solvent discharge valve V2, water discharge valve V3, air ejection valve V4, timer TM, unit contact ON/OFF counter CNT1, discharge counter CNT2, total cloth feed counter CNT3, cleaning pattern data memory 7-11, and interface 7-12. The rotary encoder 7-5 detects rotation of the blanket cylinder 5. The motor driver 7-6 drives the motor (not shown) of the printing press. The constituent elements 7-7, 7-8, 7-9, and 7-10 include valves and counters which are related to the cleaning work in the first, second, third, and fourth-color printing units. The interface 7-1 mediates signal transmission/reception to/from the central control apparatus 8. The CPU 7-1 operates in accordance with a program stored in the ROM 7-3 while accessing the RAM 7-2 or memory 7-11.

The unit ON/OFF valve V1 feeds compressed air to the ports Pa and Pb of the pneumatic cylinder 6w in the cleaning apparatus 6. When the unit ON/OFF valve V1 is turned on, the actuating rod 6w1 of the pneumatic cylinder 6w moves forward. When the unit ON/OFF valve V1 is turned off, the actuating rod 6w1 moves back. The solvent discharge valve V2, water discharge valve V3, and air ejection valve V4 discharge a solvent and water from the cleaning nozzle 6g in the cleaning apparatus 6.

The unit contact ON/OFF counter CNT1 counts the number of times of ON/OFF operation of the cleaning cloth 6i with respect to the blanket cylinder 5 in the cleaning apparatus 6. The discharge counter CNT2 counts the number of times of discharge of the solvent or water from the cleaning nozzle 6g to the cleaning cloth 6i in the cleaning apparatus 6. The total cloth feed counter CNT3 counts the total number of times of feed of the cleaning cloth 6i (the number of times of forward movement of the actuating rod 6w1) in the cleaning apparatus 6. The timer TM counts the contact ON/OFF time of the cleaning cloth 6i with respect to the blanket cylinder 5 in the cleaning apparatus 6.

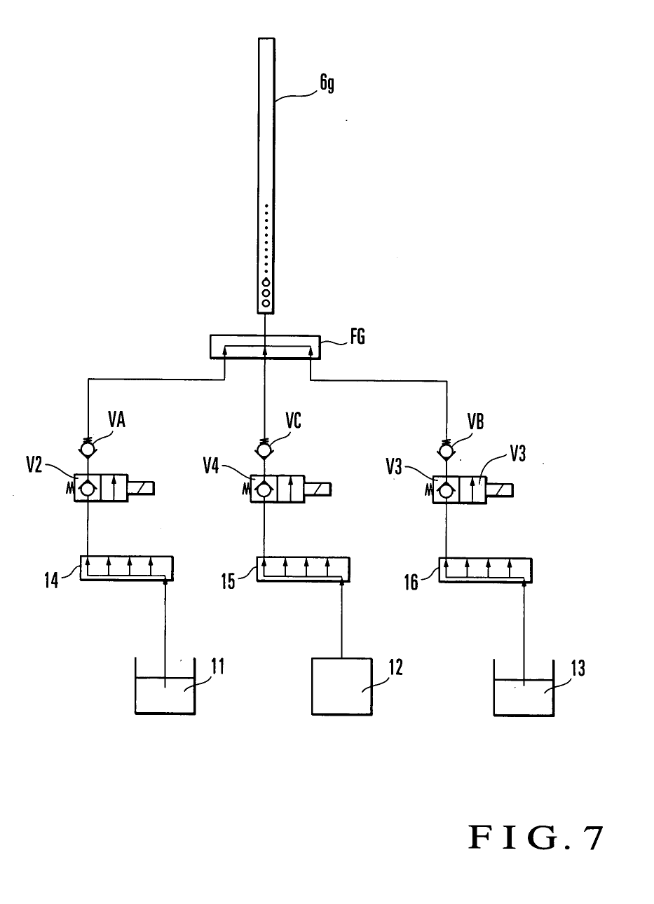

FIG. 7 shows an arrangement to discharge a solvent and water from the cleaning nozzle 6g of the cleaning apparatus 6. Referring to FIG. 7, reference numeral 11 denotes a solvent tank which stores a solvent; 12, a pressurized air source; and 13, a water tank which stores water. A first flow divider 14 distributes the solvent from the solvent tank 11 to the cleaning nozzles 6g arranged in the printing units 3 (3-1 to 3-4). A second flow divider 15 distributes compressed air from the pressurized air source 12 to the cleaning nozzles 6g arranged in the printing units 3 (3-1 to 3-4). A third flow divider 16 distributes water from the water tank 13 to the cleaning nozzles 6g arranged in the printing units 3 (3-1 to 3-4). The solvent tank 11, pressurized air source 12, water tank 13, and flow dividers 14, 15, and 16 are arranged in correspondence with all the printing units.

Each color printing unit has the solvent discharge valve V2, water discharge valve V3, and air ejection valve V4. When the solvent discharge valve V2 is turned on, the solvent from the solvent tank 11 is fed to a flow combiner FG through a check valve VA. When the water discharge valve V3 is turned on, the water from the water tank 13 is fed to the flow combiner FG through a check valve VB. When the air ejection valve V4 is turned on, the compressed air from the pressurized air source 12 is fed to the flow combiner FG through a check valve VC.

In this embodiment, to discharge the solvent, the solvent discharge valve V2 and air ejection valve V4 are turned on simultaneously. Accordingly, the solvent from the solvent tank 11 and the compressed air from the pressurized air source 12 are combined by the flow combiner FG and discharged from the cleaning nozzle 6g. To discharge water, the water discharge valve V3 and air ejection valve V4 are turned on simultaneously. Accordingly, the water from the water tank 13 and the compressed air from the pressurized air source 12 are combined by the flow combiner FG and discharged from the cleaning nozzle 6g.

The cleaning pattern data memory 7-11 includes a pattern data memory SM1 for the first-color printing unit, a pattern data memory SM2 for the second-color printing unit, a pattern data memory SM3 for the third-color printing unit, and a pattern data memory SM4 for the fourth-color printing unit. Cleaning pattern data for the color printing units, which are transferred from the central control apparatus 8, are written in the pattern data memories SM1 to SM4. Transfer of cleaning pattern data from the central control apparatus 8 will be described later.

In this embodiment, there are four kinds of cleaning patterns. Cleaning pattern data is defined for each cleaning pattern (cleaning patterns 1, 2, 3, and 4). Each cleaning pattern data contains various kinds of cleaning parameters. In this example, “cloth feed count (C1) at spray interval 1”, “cloth feed count (C2) at spray interval 2”, “solvent discharge time (t1)”, “water discharge time (t8)”, “discharge count (S1)”, “total cloth feed count (CT1)”, “drying time (t9)”, “air ejection time (t2)”, “unit ON time (t6)”, “unit OFF time (t7)”, “initial cloth feed count (CT2)”, “liquid penetration standby time (t3)”, “unit ON time (t4) in initial cloth feed”, and “unit OFF time (t5) in initial cloth feed” are used as cleaning parameters.

The “liquid penetration standby time (t3)”, “unit ON time (t4) in initial cloth feed”, and “unit OFF time (t5) in initial cloth feed” are fixed values in each cleaning pattern. In each cleaning pattern, not all the cleaning parameters are used. The cleaning parameters to be used change between the cleaning patterns.

[Cleaning Pattern 1 (Standard)]

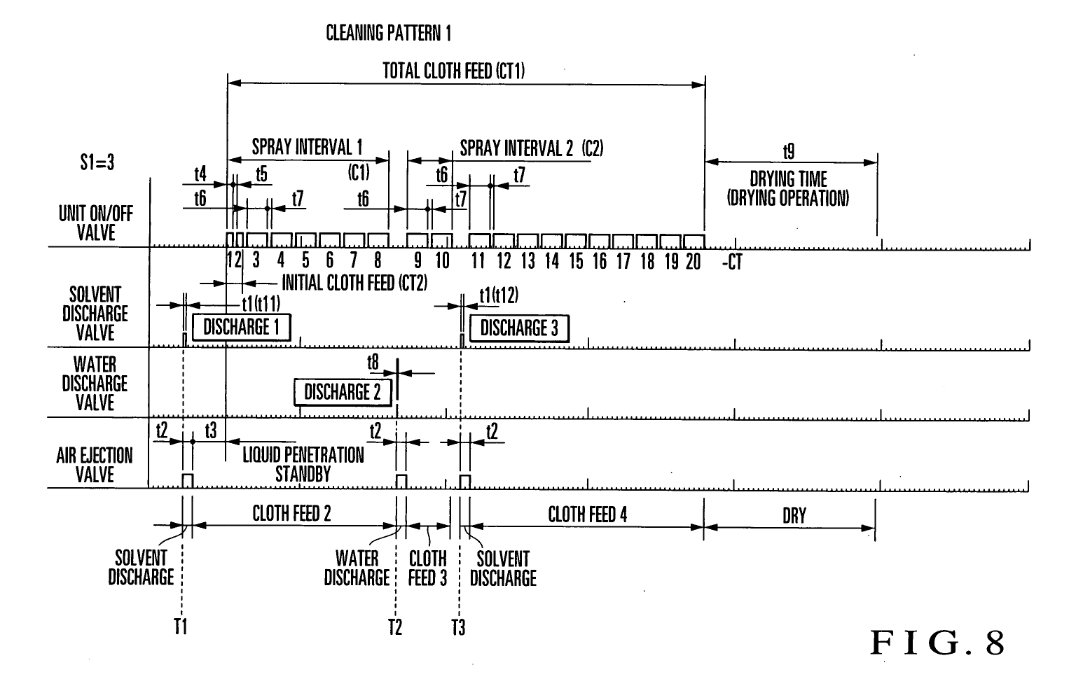

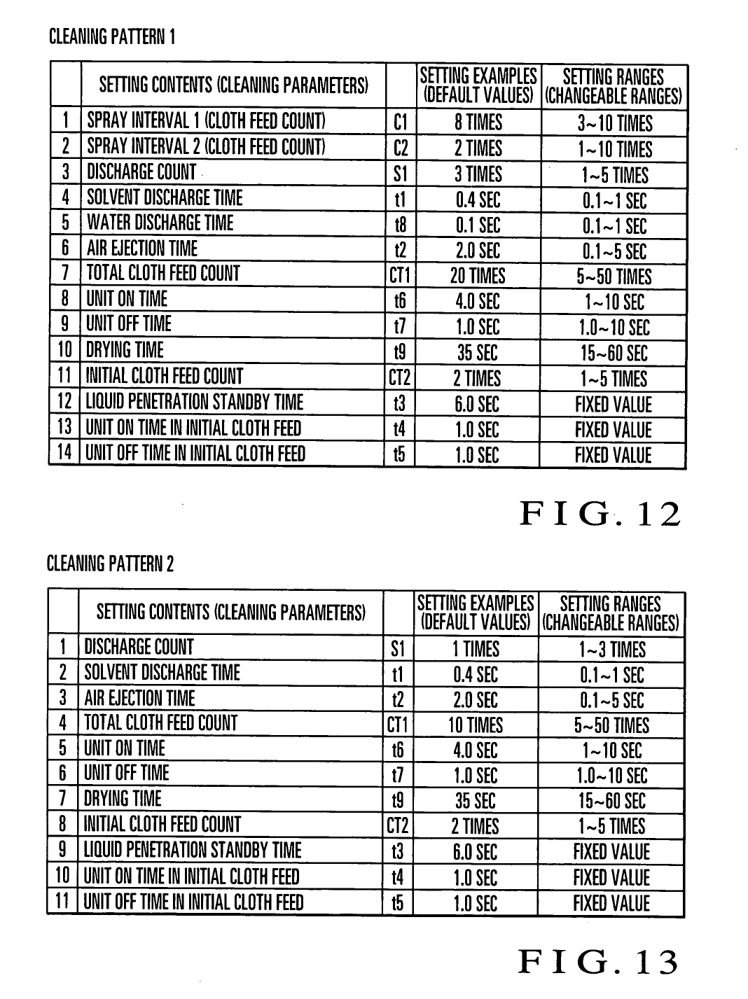

FIG. 8 shows the cleaning work according to “cleaning pattern 1”. FIG. 12 shows setting examples (default values) and setting ranges (changeable ranges) of cleaning parameters set in “cleaning pattern 1”.

In “cleaning pattern 1”, the discharge count S1 is set to S1=3 as a default value. In this example, the solvent discharge count is 2, and the water discharge count is 1. The cleaning solution is discharged three times in total.

As default values, the solvent discharge time t1 is 0.4 sec, the air ejection time t2 is 2.0 sec, the liquid penetration standby time t3 is 6.0 sec, the unit ON time t4 in initial cloth feed is 1.0 sec, the unit OFF time t5 in initial cloth feed is 1.0 sec, the unit ON time t6 in normal cloth feed is 4.0 sec, the unit OFF time t7 in normal cloth feed is 1.0 sec, the water discharge time t8 is 0.1 sec, and the drying time t9 is 35 sec.

As default values, the cloth feed count C1 at spray interval 1 (the time from the first solvent discharge to the next water discharge) is 8, the cloth feed count C2 at spray interval 2 (the time from the water discharge to the next solvent discharge) is 2, the cloth feed count (total cloth feed count) CT1 in total cloth feed (after the start of cloth feed in the unit ON time t4 to the start of the drying time t9) is 20, and the cloth feed count (initial cloth feed count) CT2 in initial cloth feed (after the start of cloth feed in the unit ON time t4 to the start of cloth feed in the unit ON time t6) is 2.

In these cleaning parameters, the liquid penetration standby time t3, unit ON time t4 in initial cloth feed, and unit OFF time t5 in initial cloth feed are fixed values. The remaining cleaning parameters can be changed by the central control apparatus 8. The change of cleaning parameters by the central control apparatus 8 will be described later.

The liquid penetration standby time t3, unit ON time t4 in initial cloth feed, and unit OFF time t5 in initial cloth feed need not always be fixed values. They may also be changeable like the remaining cleaning parameters. The unit ON time t4 in initial cloth feed is however set on the basis of the premise that the cleaning cloth 6i does not come into contact with the blanket cylinder 5. More specifically, the unit ON time t4 in initial cloth feed is set to be shorter than the operation time of the pneumatic cylinder 6w such that when the actuating rod 6w1 of the pneumatic cylinder 6w moves forward, the unit ON/OFF valve V1 is turned off before the actuating rod 6w1 completely extends.

[Cleaning Pattern 2 (Light Contamination)]

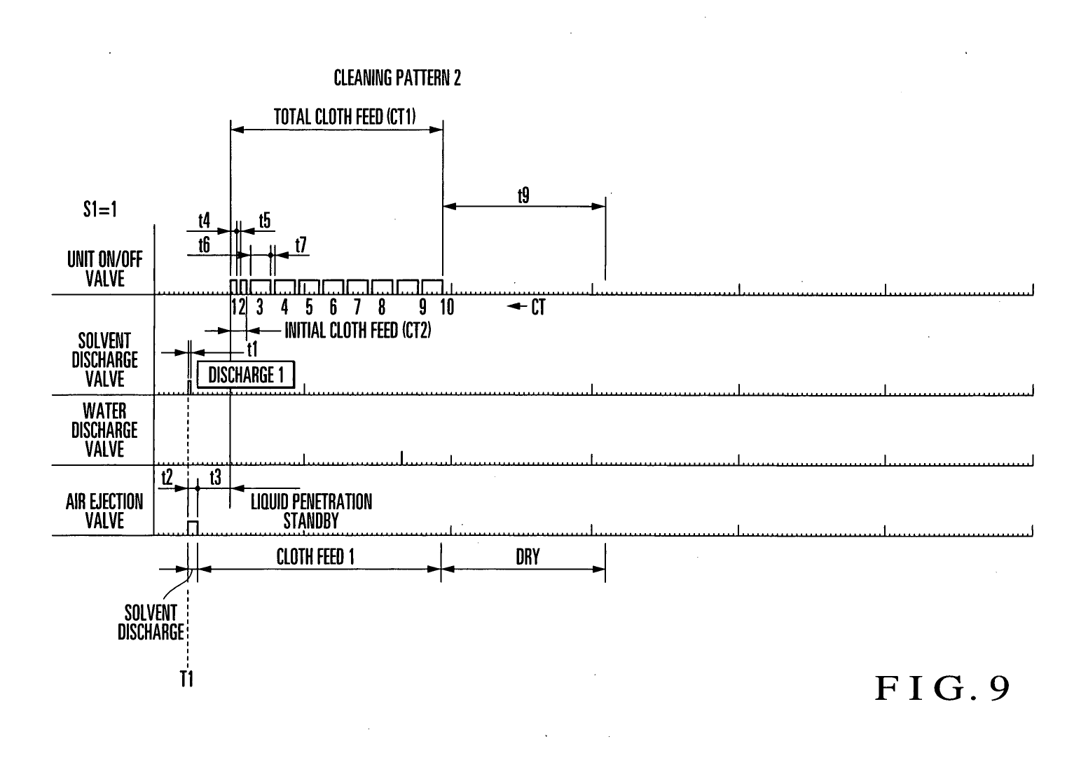

FIG. 9 shows the cleaning work according to “cleaning pattern 2”. FIG. 13 shows setting examples (default values) and setting ranges (changeable ranges) of cleaning parameters set in “cleaning pattern 2”. In “cleaning pattern 2”, the discharge count S1 is set to S1=1 as a default value. In this example, the solvent discharge count is 1, and the water discharge count is 0. The cleaning solution is discharged once in total.

As default values, the solvent discharge time t1 is 0.4 sec, the air ejection time t2 is 2.0 sec, the liquid penetration standby time t3 is 6.0 sec, the unit ON time t4 in initial cloth feed is 1.0 sec, the unit OFF time t5 in initial cloth feed is 1.0 sec, the unit ON time t6 in normal cloth feed is 4.0 sec, the unit OFF time t7 in normal cloth feed is 1.0 sec, the drying time t9 is 35 sec, the total cloth feed count CT1 is 10, and the initial cloth feed count CT2 is 2.

[Cleaning Pattern 3 (Paper Dust)]

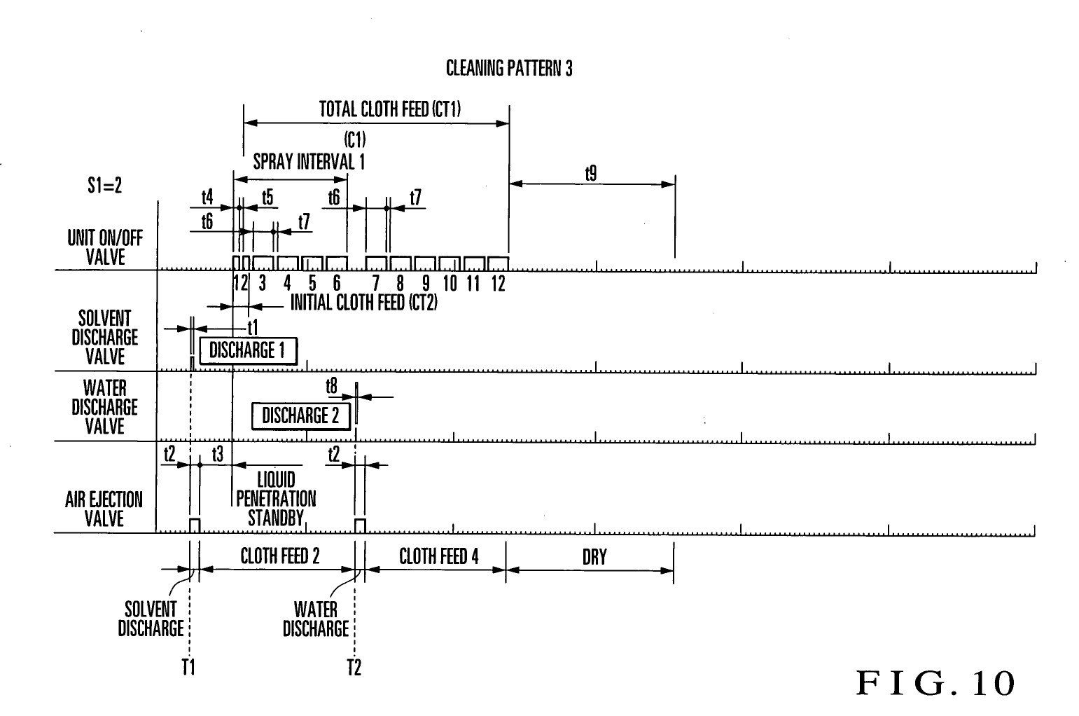

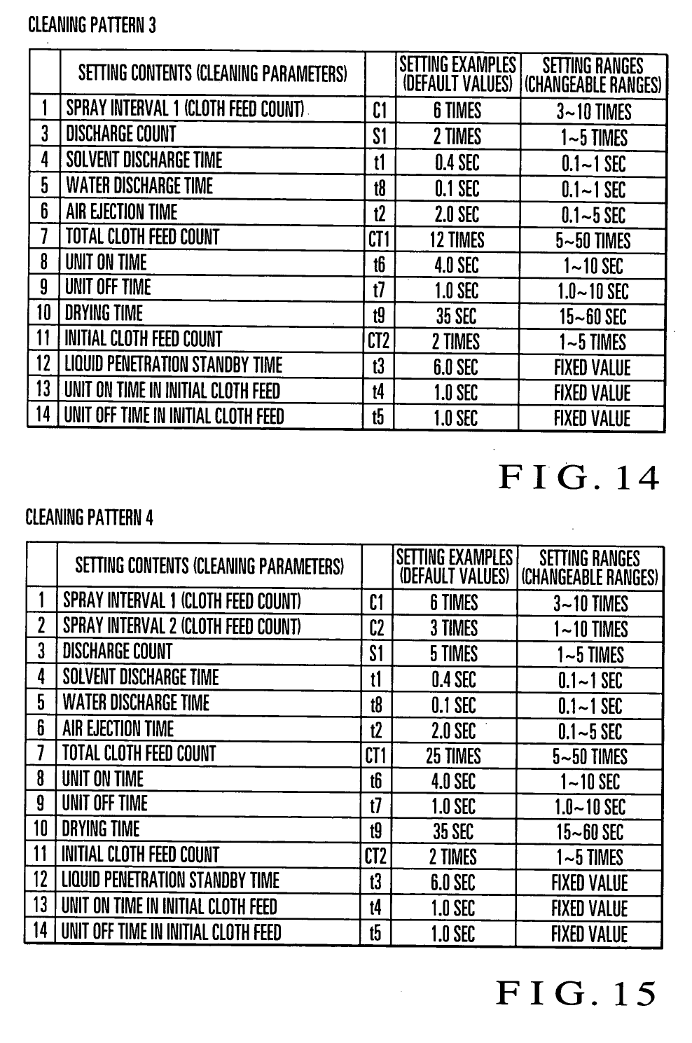

FIG. 10 shows the cleaning work according to “cleaning pattern 3”. FIG. 14 shows setting examples (default values) and setting ranges (changeable ranges) of cleaning parameters set in “cleaning pattern 3”. In “cleaning pattern 3”, the discharge count S1 is set to S1=2 as a default value. In this example, the solvent discharge count is 1, and the water discharge count is 1. The cleaning solution is discharged twice in total.

As default values, the solvent discharge time t1 is 0.4 sec, the air ejection time t2 is 2.0 sec, the liquid penetration standby time t3 is 6.0 sec, the unit ON time t4 in initial cloth feed is 1.0 sec, the unit OFF time t5 in initial cloth feed is 1.0 sec, the unit ON time t6 in normal cloth feed is 4.0 sec, the unit OFF time t7 in normal cloth feed is 1.0 sec. the water discharge time t8 is 0.1 sec, the drying time t9 is 35 sec, the cloth feed count C1 at spray interval 1 is 6, the total cloth feed count CT1 is 12, and the initial cloth feed count CT2 is 2.

[Cleaning Pattern 4 (Hard Contamination)]

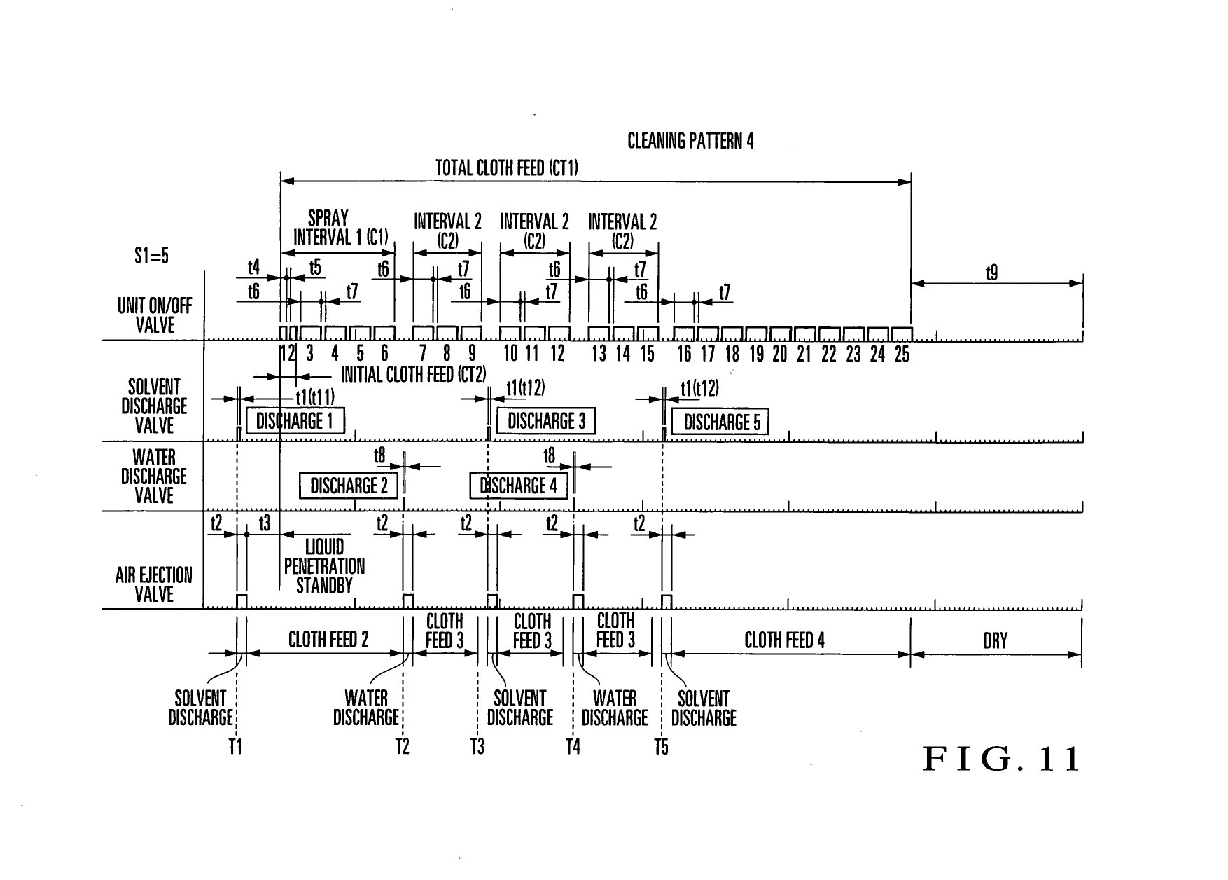

FIG. 11 shows the cleaning work according to “cleaning pattern 4”. FIG. 15 shows setting examples (default values) and setting ranges (changeable ranges) of cleaning parameters set in “cleaning pattern 4”. In “cleaning pattern 4”, the discharge count S1 is set to S1=5 as a default value. In this example, the solvent discharge count is 3, and the water discharge count is 2. The cleaning solution is discharged five times in total.

As default values, the solvent discharge time t1 is 0.4 sec, the air ejection time t2 is 2.0 sec, the liquid penetration standby time t3 is 6.0 sec, the unit ON time t4 in initial cloth feed is 1.0 sec, the unit OFF time t5 in initial cloth feed is 1.0 sec, the unit ON time t6 in normal cloth feed is 4.0 sec, the unit OFF time t7 in normal cloth feed is 1.0 sec, the water discharge time t8 is 0.1 sec, the drying time t9 is 35 sec, the cloth feed count C1 at spray interval 1 is 6, the cloth feed count C2 at spray interval 2 is 3, the total cloth feed count CT1 is 25, and the initial cloth feed count CT2 is 2.

[Cleaning work (Cleaning+Drying)]

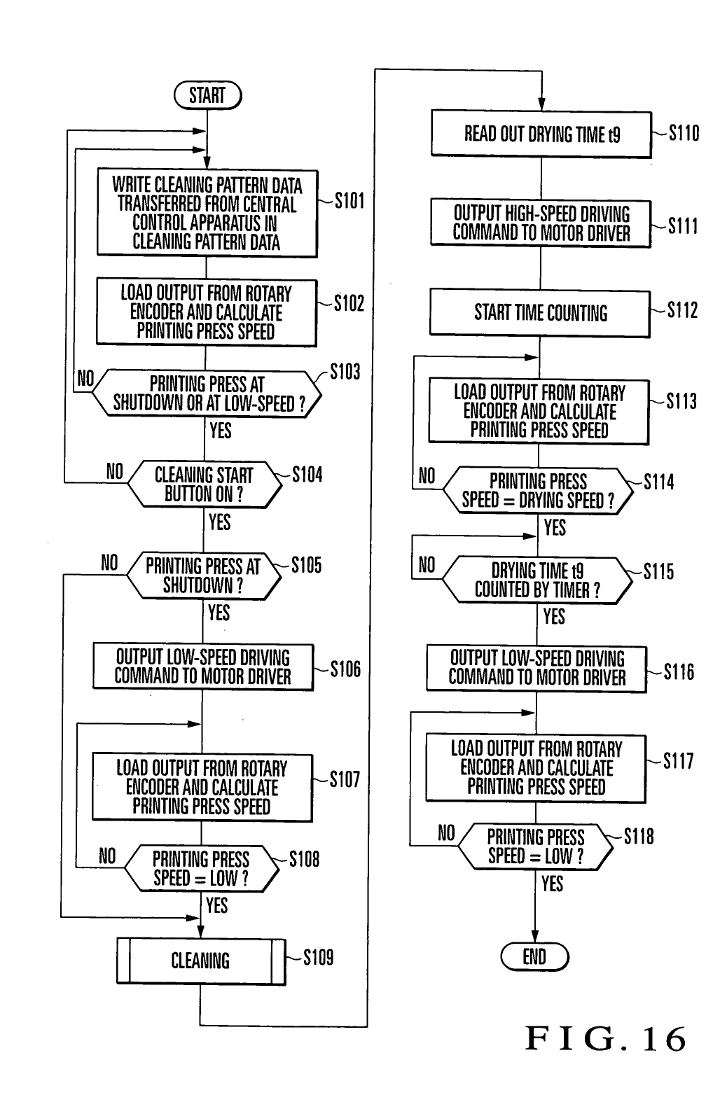

The cleaning work executed by the CPU 7-1 of the printing press control apparatus 7 will be described next with reference to the flowcharts shown in FIGS. 16 to 23. An example will be described here, in which the cleaning work is executed on the basis of “cleaning pattern 1”, and the default values are set as the cleaning parameters of “cleaning pattern 1”.

The CPU 7-1 writes, in the cleaning pattern data memory 7-11, the cleaning pattern data of “cleaning pattern 1” transferred from the central control apparatus 8 (step S101 in FIG. 16). Cleaning pattern data of “cleaning pattern 1” are present for each printing unit. Cleaning pattern data for the first-color printing unit are written in the pattern data memory SM1. Cleaning pattern data for the second-color printing unit are written in the pattern data memory SM2. Cleaning pattern data for the third-color printing unit are written in the pattern data memory SM3. Cleaning pattern data for the fourth-color printing unit are written in the pattern data memory SM4.

A description will be made below assuming that the blanket cylinder 5-1 of the first-color printing unit 3-1 should be cleaned. Simultaneously with the cleaning work of the blanket cylinder 5-1 of the first-color printing unit 3-1, the cleaning work is executed in the second, third, and fourth-color printing units in a similar manner. That is, in this embodiment, the cleaning work is executed simultaneously for all colors.

The CPU 7-1 loads the output from the rotary encoder 7-5 and calculates the speed of the printing press (step S102). It is determined on the basis of the calculated speed of the printing press whether it is at shutdown or is rotating at a low speed (step S103). If YES in step S103, the flow advances to step S104.

When the cleaning start button 7-4 is turned on in step S104, it is checked whether the printing press is at shutdown (step S105). If the printing press is not at shutdown (NO in step S105), it is determined that the printing press is at a cleaning speed. The flow immediately advances to step S109 to execute a cleaning process. If the printing press is at shutdown (YES in step S105), a low-speed driving command is fed to the motor driver 7-6 (step S106). Accordingly, the printing press starts rotating. The CPU 7-1 loads the output from the rotary encoder 7-5 and calculates the speed of the printing press (step S107). When the printing press has reached a predetermined low speed (cleaning speed) (YES in step S108), the flow advances to step S109 to execute a cleaning process.

[Cleaning Process]

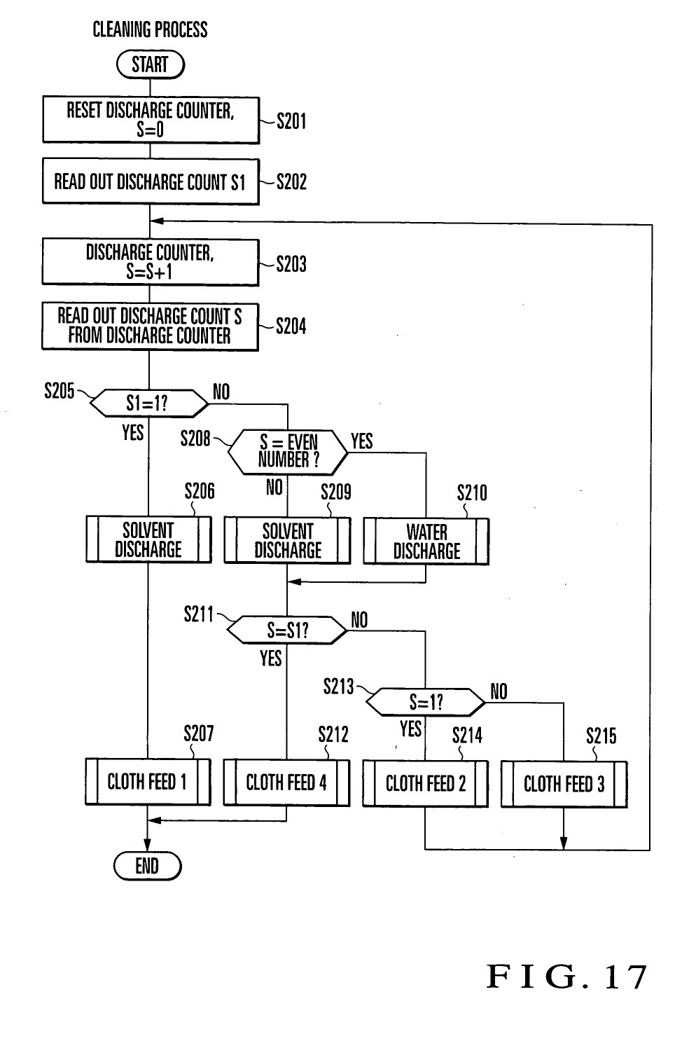

FIG. 17 shows “cleaning process” executed in step S109. In “cleaning process”, the CPU 7-1 resets a count value S of the discharge counter CNT2 to S=0 (step S210). In addition, the discharge count S1 (S1=3) is read out from the pattern data memory SM1 (step S202). The count value S of the discharge counter CNT2 is incremented by one to S=1 (step S203). The incremented count value S (S=1) of the discharge counter CNT2 is read (step S204). The discharge count S1 read out in step S202 is checked (step S205). If S1=1, the flow advances to step S206. Otherwise, the flow advances to step S208.

In this case, since the discharge count S1 read out in step S202 is S1=3, the flow advances to step S208. In step S208, it is checked whether the count value S of the discharge counter CNT2 read in step S204 is an even number or odd number. If the count value S is an odd number, the flow advances to “solvent discharge process” in step S209. If the count value S is an even number, the flow advances to “water discharge process” in step S210. In this case, since the count value S of the discharge counter CNT2 read in step S204 is S=1, the flow advances to “solvent discharge process” in step S209.

[Solvent Discharge Process]

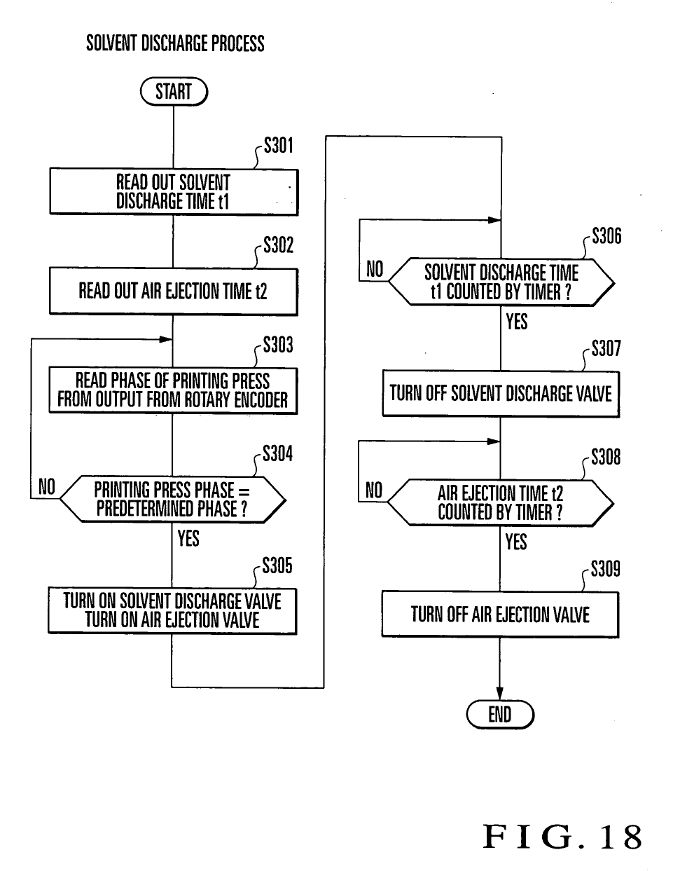

FIG. 18 shows “solvent discharge process” executed in step S209. In “solvent discharge process”, the CPU 7-1 reads out the solvent discharge time t1 (t1=0.4 sec) and air ejection time t2 (t2=2.0 sec) from the pattern data memory SM1 (steps S301 and S302). The CPU 7-1 reads the phase of the printing press (the rotational angular position of the blanket cylinder 5) from the output from the rotary encoder 7-5 (step S303). When the printing press has a predetermined phase (YES in step S304), the solvent discharge valve V2 and air ejection valve V4 are turned on (step S305: time T1 shown in FIG. 8). Accordingly, the solvent from the solvent tank 11 is fed to the flow combiner FG, and the compressed air from the pressurized air source 12 is fed to the flow combiner FG. The solvent is discharged from the cleaning nozzle 6g of the cleaning apparatus 6 to the cleaning cloth 6i.

At the same time, the timer TM starts counting time. When the time counted by the timer TM has reached the solvent discharge time t1 (t1=0.4 sec) read out in step S301 (YES in step S306), the solvent discharge valve V2 turned on in step S305 is turned off (step S307). When the time counted by the timer TM has reached the air ejection time t2 (t2=2.0 sec) read out in step S302 (YES in step S308), the air ejection valve V4 turned on in step S305 is turned off (step S309). The first solvent discharge to the cleaning cloth 6i is thus ended.

When the first solvent discharge is ended, the CPU 7-1 checks the count value S of the discharge counter CNT2 (step S211 in FIG. 17). If S=S1, the flow advances to “cloth feed 4 process” in step S212. Otherwise, the flow advances to step S213. In this case, since S=1, and S1=3, the flow advances to step S213. If S=1 in step S213, the flow advances to “cloth feed 2 process” in step S214. Otherwise, the flow advances to “cloth feed 3 process” in step S215. In this case, since S=1, the flow advances to “cloth feed 2 process”.

[Cloth Feed 2 Process]

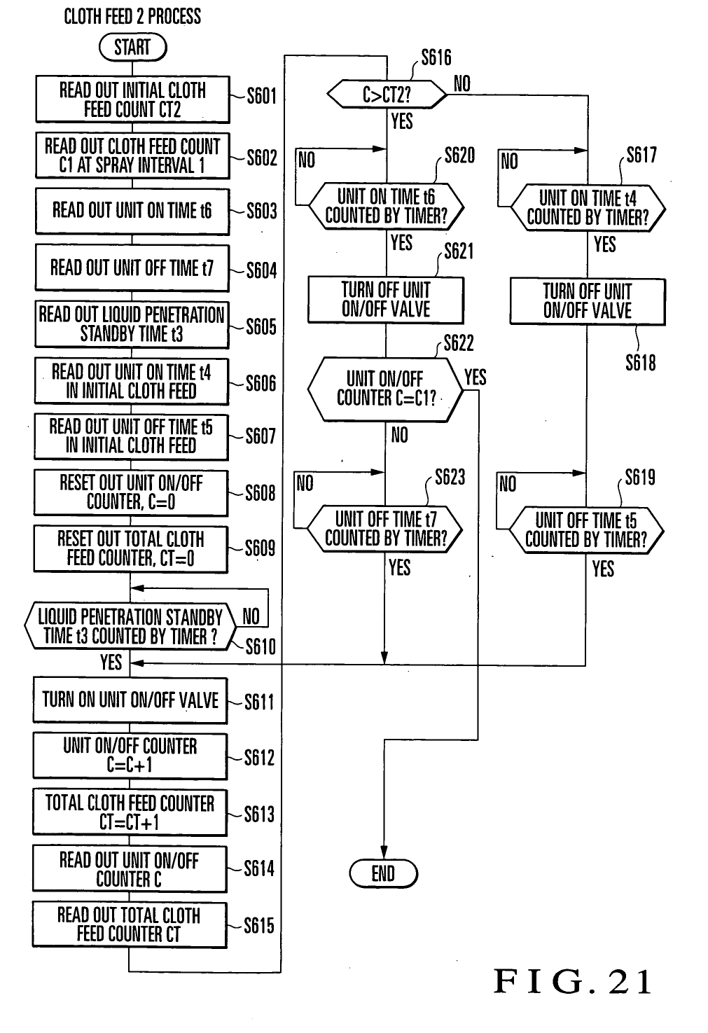

FIG. 21 shows “cloth feed 2 process” executed in step S214. In “cloth feed 2 process”, the CPU 7-1 reads out, from the pattern data memory SM1, the initial cloth feed count CT2 (CT2=2), the cloth feed count C1 at spray interval 1 (C1=8), the unit ON time t6 (t6=4.0 sec), the unit OFF time t7 (t7=1.0 sec), the liquid penetration standby time t3 (t3=6.0 sec), the unit ON time t4 in initial cloth feed (t4=1.0 sec), and the unit OFF time t5 in initial cloth feed (t5=1.0 sec) (steps S601 to S607).

A count value C of the unit contact ON/OFF counter CNT1 is reset to C=0 (step S608). In addition, a count value CT of the total cloth feed counter CNT3 is reset to CT=0 (step S609). After the liquid penetration standby time t3 (t3=6.0 sec) read out in step S605 elapses (YES in step S610), the unit ON/OFF valve V1 is turned on (step S611). In this case, when the elapse of the liquid penetration standby time t3 is waited, the solvent discharged from the cleaning nozzle 6g to the cleaning cloth 6i spreads from the discharged portion and penetrates widely.

The CPU 7-1 increments the count value C of the unit contact ON/OFF counter CNT1 by one to C=1 (step S612) and also increments the count value CT of the total cloth feed counter CNT3 by one to CT=1 (step S613). The CPU 7-1 reads the incremented count value C of the unit contact ON/OFF counter CNT1 and the incremented count value CT of the total cloth feed counter CNT3 (steps S614 and S615).

The count value C of the unit contact ON/OFF counter CNT1 read in step S612 (C=1) is compared with the initial cloth feed count CT2 (CT2=2) read out in step S601 (step S616). If C>CT2, the flow advances to step S620. Otherwise, the flow advances to step S617. In this case, since C=1, and CT2=2, flow advances to step S617. In step S617, the CPU 7-1 waits until the unit ON time t4 (t4=1.0 sec) in initial cloth feed read out in step S606 elapses. After the unit ON time t4 elapses (YES in step S617), the unit ON/OFF valve V1 turned on in step S611 is turned off (step S618).

At this time, the unit ON/OFF valve V1 is kept on for t4=1.0 sec. Accordingly, the actuating rod 6w1 of the pneumatic cylinder 6w in the cleaning apparatus 6 moves forward. In accordance with the forward movement of the actuating rod 6w1, the cleaning cloth 6i is wound on the winding roll 6m by a predetermined amount. In this case, since the unit ON/OFF valve V1 is turned off before the actuating rod 6w1 completely extends, the cleaning cloth 6i never comes into contact with the blanket cylinder 5. That is, the cleaning cloth 6i is wound on the winding roll 6m by a predetermined amount without coming into contact with the blanket cylinder 5.

After the unit ON/OFF valve V1 is turned off in step S618, the CPU 7-1 waits until the unit OFF time t5 in initial cloth feed (t5=1.0 sec) read out in step S607 elapses (YES in step S619). The flow returns to step S611 to turn on the unit ON/OFF valve V1 again. In this case, since C=2, and CT2=2, the flow advances to the process from step S617, as described above. Accordingly, the cleaning cloth 6i is wound again on the winding roll 6m by a predetermined amount without coming into contact with the blanket cylinder 5. That is, cloth feed is done twice (initial cloth feed) including the preceding cloth feed so that the solvent discharged portion of the cleaning cloth 6i opposes the contact portion to the blanket cylinder 5.

When the second cloth feed is ended by the process in steps S617 to S619, the CPU 7-1 returns to step S611 to turn on the unit ON/OFF valve V1 again. In this case, since C=3, and CT2=2, C>CT2. The flow advances to the process from step S620. In step S620, the CPU 7-1 waits until the unit ON time t6 (t6=4.0 sec) read out in step S603 elapses. After the unit ON time t6 elapses (YES in step S620), the unit ON/OFF valve V1 turned on in step S611 is turned off (step S621).

At this time, the unit ON/OFF valve V1 is kept ON for t6=4.0 sec. Accordingly, the actuating rod 6w1 of the pneumatic cylinder 6w in the cleaning apparatus 6 moves forward. In accordance with the forward movement of the actuating rod 6w1, the cleaning cloth 6i is wound on the winding roll 6m by a predetermined amount. Simultaneously, the cleaning cloth 6i comes into contact with the blanket cylinder 5. The unit ON time t6 is a time in which the blanket cylinder 5 rotates by several revolutions while keeping the cleaning cloth 6i pressed against its surface. During the unit ON time t6, the solvent is supplied from the cleaning cloth 6i to the surface of the blanket cylinder 5.

When the unit ON/OFF valve V1 is turned off in step S621, the actuating rod 6w1 of the pneumatic cylinder 6w in the cleaning apparatus 6 moves back, and the cleaning cloth 6i separates from the surface of the blanket cylinder 5. Simultaneously as the cleaning cloth 6i separates from the surface of the blanket cylinder 5, the CPU 7-1 compares the count value C of the unit contact ON/OFF counter CNT1 with the cloth feed count C1 (C1=8) read out in step S602 (step S622).

In this case, C=3, and C≠C1. Hence, after the unit OFF time t7 (t7=1.0 sec) elapses in step S623, the flow returns to step S611 to repeatedly intermittently bring the cleaning cloth 6i into contact with the blanket cylinder 5, i.e., repeatedly execute ON/OFF operation of the cleaning cloth 6i with respect to the blanket cylinder 5. When C=C1 is satisfied by repeating ON/OFF, i.e., when the number of times of ON/OFF of the cleaning cloth 6i with respect to the blanket cylinder 5 including the number of times of initial cloth feed has reached 8 (YES in step S622), “cloth feed 2 process” is ended, and the flow returns to step S203 shown in FIG. 17.

In “cloth feed 2 process”, the cleaning cloth 6i is damp with the solvent during the first half of the six repetitive operations of keeping the cleaning cloth 6i in contact with the surface of the blanket cylinder 5 for the time t6 and then keeping the cleaning cloth 6i separate from the surface of the blanket cylinder 5 for the time t7. Hence, the solvent is supplied from the cleaning cloth 6i to the surface of the blanket cylinder 5. This solvent removes ink sticking to the surface of the blanket cylinder 5 and lifts it off the surface of the blanket cylinder 5. In the second half, the dry portion of the cleaning cloth 6i fed from the supply roll 6j comes into contact with the surface of the blanket cylinder 5. The dry cleaning cloth 6i wipes the ink lifted off the surface of the blanket cylinder 5.

After the end of “cloth feed 2 process”, the CPU 7-1 increments the count value S of the discharge counter CNT2 by one to S=2 in step S203 and reads the incremented count value S (S=2) of the discharge counter CNT2 (step S204). If NO in step S205, the flow advances to step S208. If YES in step S208, the flow advances to “water discharge process” in step S210.

[Water Discharge Process]

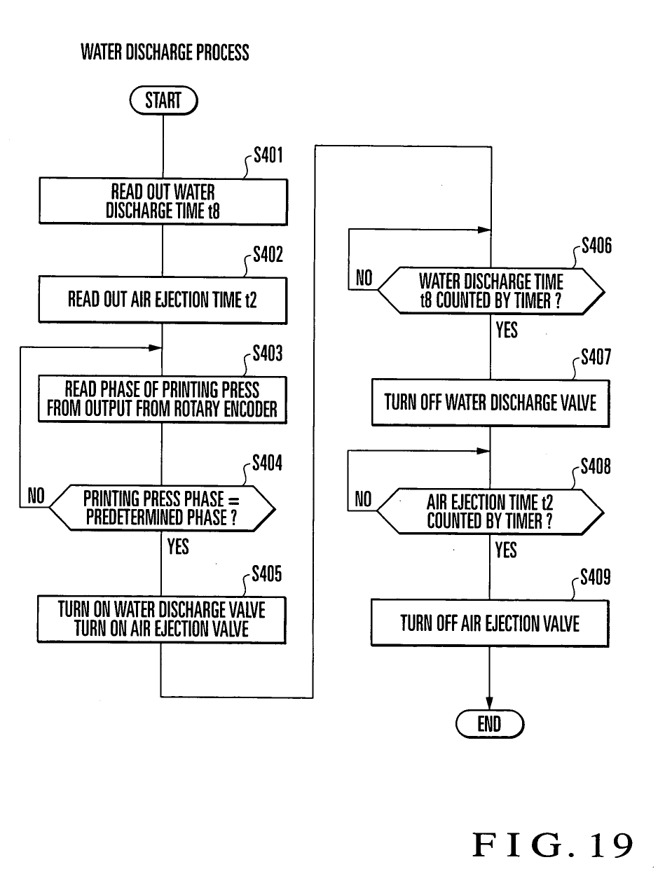

FIG. 19 shows “water discharge process” executed in step S210. In “water discharge process”, the CPU 7-1 reads out the water discharge time t8 (t8=0.1 sec) and air ejection time t2 (t2=2.0 sec) from the pattern data memory SM1 (steps S401 and S402). The CPU 7-1 reads the phase of the printing press from the output from the rotary encoder 7-5 (step S403). When the printing press has a predetermined phase (YES in step S404), the water discharge valve V3 and air ejection valve V4 are turned on (step S405: time T2 shown in FIG. 8). Accordingly, the water from the water tank 13 is fed to the flow combiner FG, and the compressed air from the pressurized air source 12 is fed to the flow combiner FG. The water is discharged from the cleaning nozzle 6g of the cleaning apparatus 6 to the cleaning cloth 6i.

At the same time, the timer TM starts counting time. When the time counted by the timer TM has reached the water discharge time t8 (t8=0.1 sec) read out in step S401 (YES in step S406), the water discharge valve V3 turned on in step S405 is turned off (step S407). When the time counted by the timer TM has reached the air ejection time t2 (t2=2.0 sec) read out in step S402 (YES in step S408), the air ejection valve V4 turned on in step S405 is turned off (step S409). The water discharge to the cleaning cloth 6i is thus ended.

When the water discharge is ended, the CPU 7-1 checks the count value S of the discharge counter CNT2 (step S211 in FIG. 17). If S=S1, the flow advances to “cloth feed 4 process” in step S212. Otherwise, the flow advances to step S213. In this case, since S=2, and S1=3, the flow advances to step S213. If S=1 in step S213, the flow advances to “cloth feed 2 process” in step S214. Otherwise, the flow advances to “cloth feed 3 process” in step S215. In this case, since S=2, the flow advances to “cloth feed 3 process”.

[Cloth Feed 3 Process]

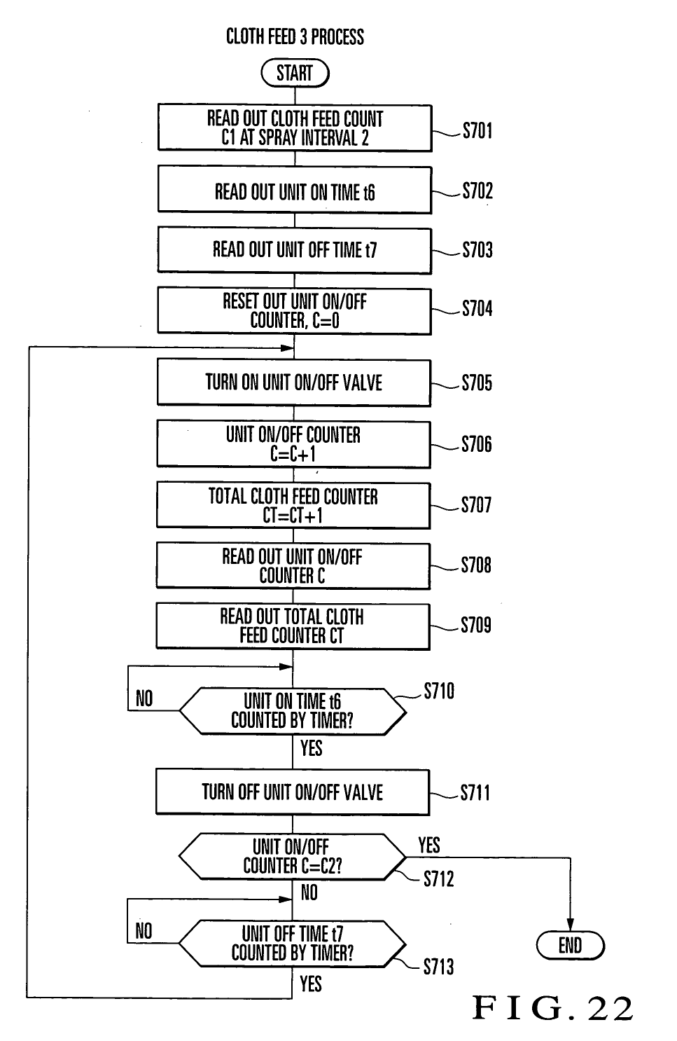

FIG. 22 shows “cloth feed 3 process” executed in step S215. In “cloth feed 3 process”, the CPU 7-1 reads out, from the pattern data memory SM1, the cloth feed count C2 at spray interval 2 (C2=2), the unit ON time t6 (t6=4.0 sec), and the unit OFF time t7 (t7=1.0 sec) (steps S701 to S703).

The count value C of the unit contact ON/OFF counter CNT1 is reset to C=0 (step S704). The unit ON/OFF valve V1 is turned on (step S705). In addition, the count value C of the unit contact ON/OFF counter CNT1 is incremented by one to C=1 (step S706). The count value CT of the total cloth feed counter CNT3 is incremented by one to CT=9 (step S707). The incremented count value C of the unit contact ON/OFF counter CNT1 and the incremented count value CT of the total cloth feed counter CNT3 are read (steps S708 and S709). After the unit ON time t6 (t6=4.0 sec) read out in step S702 elapses (YES in step S710), the unit ON/OFF valve V1 turned on in step S705 is turned off (step S711).

At this time, the unit ON/OFF valve V1 is kept ON for t6=4.0 sec. Accordingly, the actuating rod 6w1 of the pneumatic cylinder 6w in the cleaning apparatus 6 moves forward. The cleaning cloth 6i is wound on the winding roll 6m by a predetermined amount. Simultaneously, the cleaning cloth 6i comes into contact with the blanket cylinder 5. During the unit ON time t6, the water is supplied from the cleaning cloth 6i to the surface of the blanket cylinder 5. With this water, paper dust is wiped off the surface of the blanket cylinder 5.

When the unit ON/OFF valve V1 is turned off in step S711, the actuating rod 6w1 of the pneumatic cylinder 6w in the cleaning apparatus 6 moves back, and the cleaning cloth 6i separates from the surface of the blanket cylinder 5. Simultaneously as the cleaning cloth 6i separates from the surface of the blanket cylinder 5, the CPU 7-1 compares the count value C of the unit contact ON/OFF counter CNT1 with the cloth feed count C2 (C2=2) read out in step S701 (step S712).

In this case, C=1, and C≠C2. Hence, after the unit OFF time t7 (t7=1.0 sec) elapses in step S713, the flow returns to step S705 to execute ON/OFF operation of the cleaning cloth 6i with respect to the blanket cylinder 5 again. When C=C2 is satisfied, i.e., when the number of times of ON/OFF of the cleaning cloth 6i with respect to the blanket cylinder 5 has reached 2 (YES in step S712), “cloth feed 3 process” is ended, and the flow returns to step S203 shown in FIG. 17.

After the end of “cloth feed 3 process”, the CPU 7-1 increments the count value S of the discharge counter CNT2 by one to S=3 in step S203 and reads the incremented count value S (S=3) of the discharge counter CNT2 (step S204). If NO in step S205, the flow advances to step S208. If NO in step S208, the flow advances to “solvent discharge process” in step S209. “Solvent discharge process” is executed in accordance with the flowchart shown in FIG. 18 to execute the second solvent discharge to the cleaning cloth 6i. When the second cleaning solution discharge is ended, the CPU 7-1 checks the count value S of the discharge counter CNT2 (step S211 in FIG. 17). In this case, since S=3, and S1=3, the flow advances to “cloth feed 4 process” in step S212.

[Cloth Feed 4 Process]

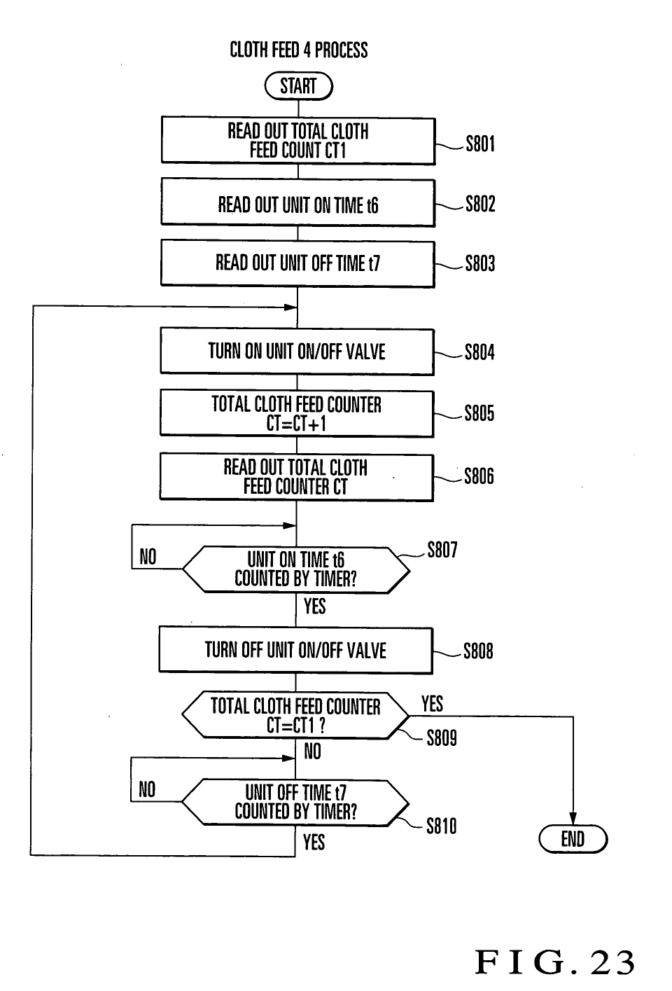

FIG. 23 shows “cloth feed 4 process” executed in step S212. In “cloth feed 4 process”, the CPU 7-1 reads out, from the pattern data memory SM1, the total cloth feed count CT1 (CT1=20), the unit ON time t6 (t6=4.0 sec), and the unit OFF time t7 (t7=1.0 sec) (steps S801 to S803).

The unit ON/OFF valve V1 is turned on (step S804). The count value CT of the total cloth feed counter CNT3 is incremented by one to CT=11 (step S805). The incremented count value CT of the total cloth feed counter CNT3 is read (step S806). After the unit ON time t6 (t6=4.0 sec) elapses (YES in step S807), the unit ON/OFF valve V1 turned on in step S804 is turned off (step S808).

In this case, the count value CT of the total cloth feed counter CNT3 has not reached CT1 in step S809 (NO in step S809). Hence, after the unit OFF time t7 (t7=1.0 sec) elapses in step S810, the CPU 7-1 returns to step S804 to repeatedly execute ON/OFF operation of the cleaning cloth 6i with respect to the blanket cylinder 5. When CT=CT1 is satisfied by repeating ON/OFF, i.e., when the number of times of ON/OFF of the cleaning cloth 6i with respect to the blanket cylinder 5 including the number of times of initial cloth feed has reached 20 (YES in step S809), “cloth feed 4 process” is ended, and “cleaning process” shown in FIG. 17 is ended.

In “cloth feed 4 process”, the cleaning cloth 6i is damp with the solvent during the first half of the 10 repetitive operations of keeping the cleaning cloth 6i in contact with the surface of the blanket cylinder 5 for the time t6 and then keeping the cleaning cloth 6i separate from the surface of the blanket cylinder 5 for the time t7. Hence, the ink which is not completely wiped in “cloth feed 2 process” and “cloth feed 3 process” is lifted off the surface of the blanket cylinder 5 by the solvent. In the second half, the dry portion of the cleaning cloth 6i fed from the supply roll 6j comes into contact with the surface of the blanket cylinder 5. The dry cleaning cloth 6i wipes the ink lifted off the surface of the blanket cylinder 5.

After the end of “cleaning process”, the CPU 7-1 reads out the drying time t9 (t9=35 sec) from the pattern data memory SM1 (step S110 shown in FIG. 16). A high-speed driving command is fed to the motor driver 7-6 (step S111). Simultaneously, the timer TM starts counting time (step S112). The CPU 7-1 loads the output from the rotary encoder 7-5 and calculates the speed of the printing press (step S113). When the printing press has reached a predetermined high speed (drying speed) (YES in step S114), check of the time counted by the timer TM which has started counting time in step S112 is repeated (step S115).

When the time counted by the timer TM has reached the drying time t9 read out in step S110 (YES in step S115), a low-speed driving command is fed to the motor driver 7-6 (step S116) to set the printing press to a low rotational speed (steps S117 and S118). The cleaning work (cleaning+drying) according to “cleaning pattern 1” is ended. After cleaning, the cleaning solution (solvent and water) sticks to the surface of the blanket cylinder 5. When, after cleaning, the blanket cylinder 5 is rotated at a higher speed than in cleaning, drying of the cleaning solution sticking to the surface of the blanket cylinder 5 is promoted. Hence, the surface of the blanket cylinder 5 dries in a short time.

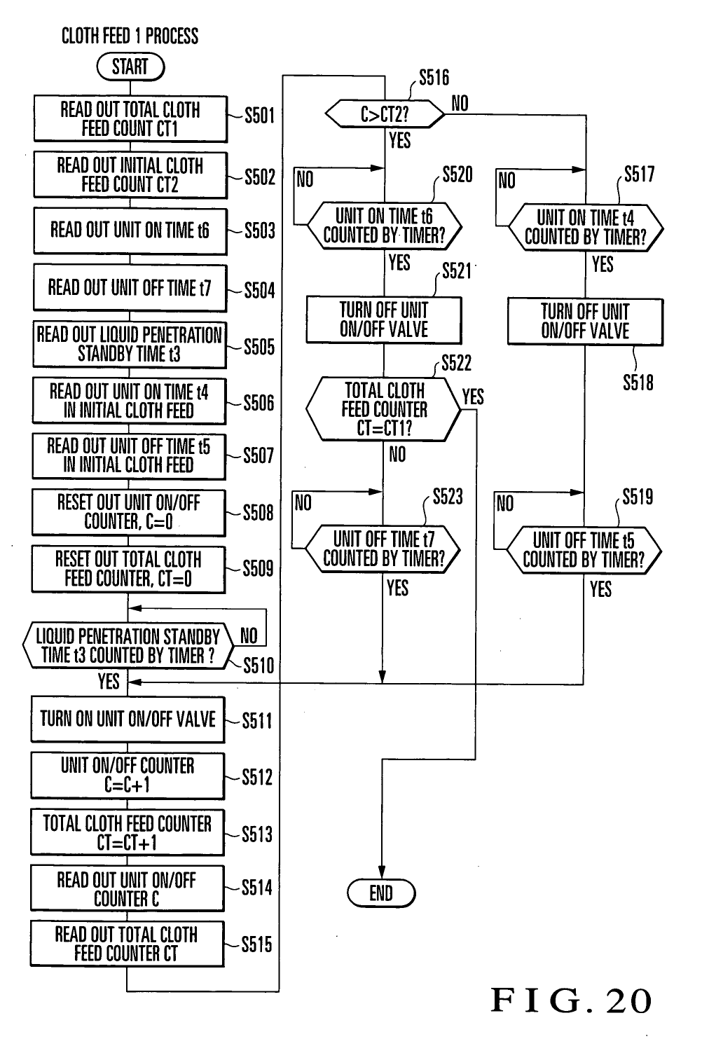

The cleaning work according to “cleaning pattern 1” has been described above. The cleaning jobs according to “cleaning pattern 2”, “cleaning pattern 3”, and “cleaning pattern 4” are also executed in accordance with the flowcharts shown in FIGS. 16 to 23. In “cleaning pattern 2”, “cloth feed 1 process” is executed after “solvent discharge process”. FIG. 20 shows “cloth feed 1 process”. In “cloth feed 1 process”, the CPU 7-1 reads out, from the pattern data memory SM1, the total cloth feed count CT1, unit ON time t6, unit OFF time t7, liquid penetration standby time t3, unit ON time t4 in initial cloth feed, and unit OFF time t5 in initial cloth feed (steps S501 to S507). By the process in steps S510 to S523 corresponding to steps S610 to S623 shown in FIG. 21, liquid penetration standby, two initial cloth feed processes, and 10 total cloth feed processes including the two initial cloth feed processes are executed in accordance with the timing chart shown in FIG. 9.

[Central Control Apparatus]

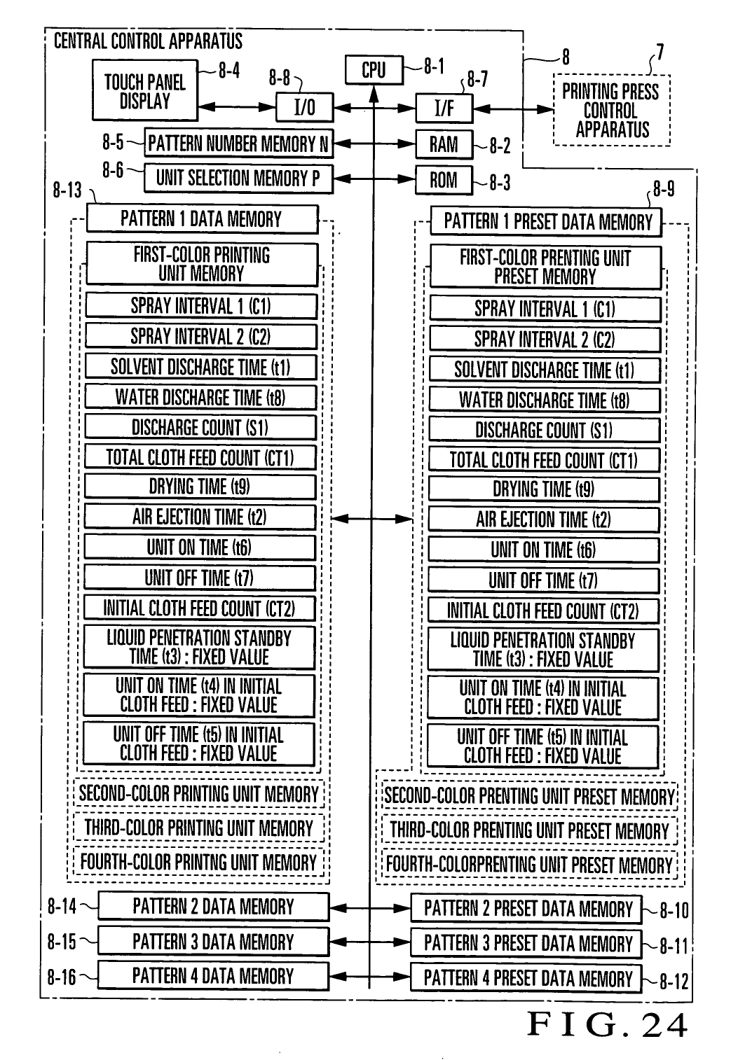

The central control apparatus 8 shown in FIG. 6 has the arrangement shown in FIG. 24. Referring to FIG. 24, the central control apparatus 8 comprises a CPU 8-1, RAM 8-2, ROM 8-3, touch panel display 8-4, a pattern number memory 8-5, unit selection memory 8-6, interface 8-7, and interface 8-8. The pattern number memory 8-5 is used to write the preceding value of a pattern number (cleaning pattern number) N of the cleaning pattern. The unit selection memory 8-6 is used to write the preceding value of a unit number (printing unit number) P of the printing unit. The interface 8-7 mediates signal transmission/reception to/from the printing control apparatus 7. The interface 8-8 mediates signal transmission/reception to/from the display 8-4. The preceding values of the cleaning pattern number N and printing unit number P to be written in the pattern number memory 8-5 and unit selection memory 8-6 will be described later. At the time of shipment from the factory, N=1 is stored in the pattern number memory 8-5 as the cleaning pattern number N. P=1 is stored in the unit selection memory 8-6 as the printing unit number P.

The central control apparatus 8 also comprises a pattern 1 preset data memory 8-9, pattern 2 preset data memory 8-10, pattern 3 preset data memory 8-11, and pattern 4 preset data memory 8-12. The preset data of cleaning pattern 1 (the default values of cleaning pattern data of cleaning pattern 1) for each color printing unit are written in the pattern 1 preset data memory 8-9. The preset data of cleaning pattern 2 (the default values of cleaning pattern data of cleaning pattern 2) for each color printing unit are written in the pattern 2 preset data memory 8-10. The preset data of cleaning pattern 3 (the default values of cleaning pattern data of cleaning pattern 3) for each color printing unit are written in the pattern 3 preset data memory 8-11. The preset data of cleaning pattern 4 (the default values of cleaning pattern data of cleaning pattern 4) for each color printing unit are written in the pattern 4 preset data memory 8-12. The preset data are written in the memories 8-9 to 8-12 at the time of shipment from the factory and cannot be erased. The default values of the cleaning pattern data of cleaning patterns 1 to 4 are shown in FIGS. 12 to 15, and a description thereof will be omitted here.

The central control apparatus 8 also comprises a pattern 1 data memory 8-13, pattern 2 data memory 8-14, pattern 3 data memory 8-15, and pattern 4 data memory 8-16. The cleaning pattern data of cleaning pattern 1 is written in the pattern 1 data memory 8-13. The cleaning pattern data of cleaning pattern 2 is written in the pattern 2 data memory 8-14. The cleaning pattern data of cleaning pattern 3 is written in the pattern 3 data memory 8-15. The cleaning pattern data of cleaning pattern 4 is written in the pattern 4 data memory 8-16. At the time of shipment from the factory, the preset data of cleaning pattern 1 in the memory 8-9 is copied to the memory 8-13. The preset data of cleaning pattern 2 in the memory 8-10 is copied to the memory 8-14. The preset data of cleaning pattern 3 in the memory 8-11 is copied to the memory 8-15. The preset data of cleaning pattern 4 in the memory 8-12 is copied to the memory 8-16. The preset data copied to the memories 8-13 to 8-16 can freely be written.

[Cleaning Parameter Change Operation Window]

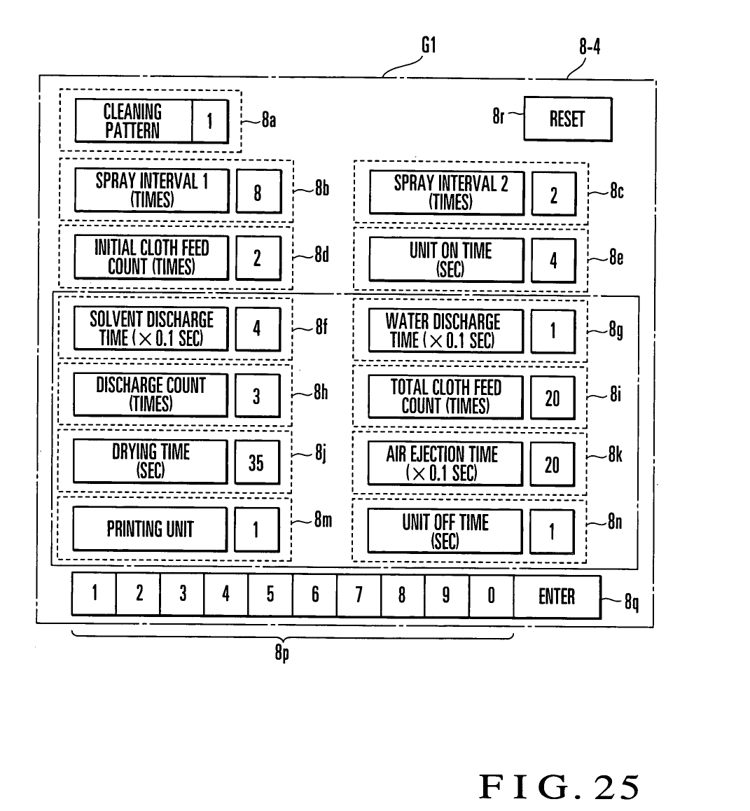

FIG. 25 shows a cleaning parameter change operation window displayed on the display 8-4. A cleaning parameter change operation window G1 has a display portion 8a of the cleaning pattern number (N), a display portion 8b of the cloth feed count (C1) at spray interval 1, a display portion 8c of the cloth feed count (C2) at spray interval 2, a display portion 8d of the initial cloth feed count (CT2), a display portion 8e of the unit ON time (t6), a display portion 8f of the solvent discharge time (t1), a display portion 8g of the water discharge time (t8), a display portion 8h of the discharge count (S1), a display portion 8i of the total cloth feed count (CT1), a display portion 8j of the drying time (t9), a display portion 8k of the air ejection time (t2), a display portion 8m of the printing unit number (P), a display portion 8n of the unit OFF time (t7), a ten-key pad 8p, an enter key 8q, and a reset key 8r.

[Change of Cleaning Parameters]

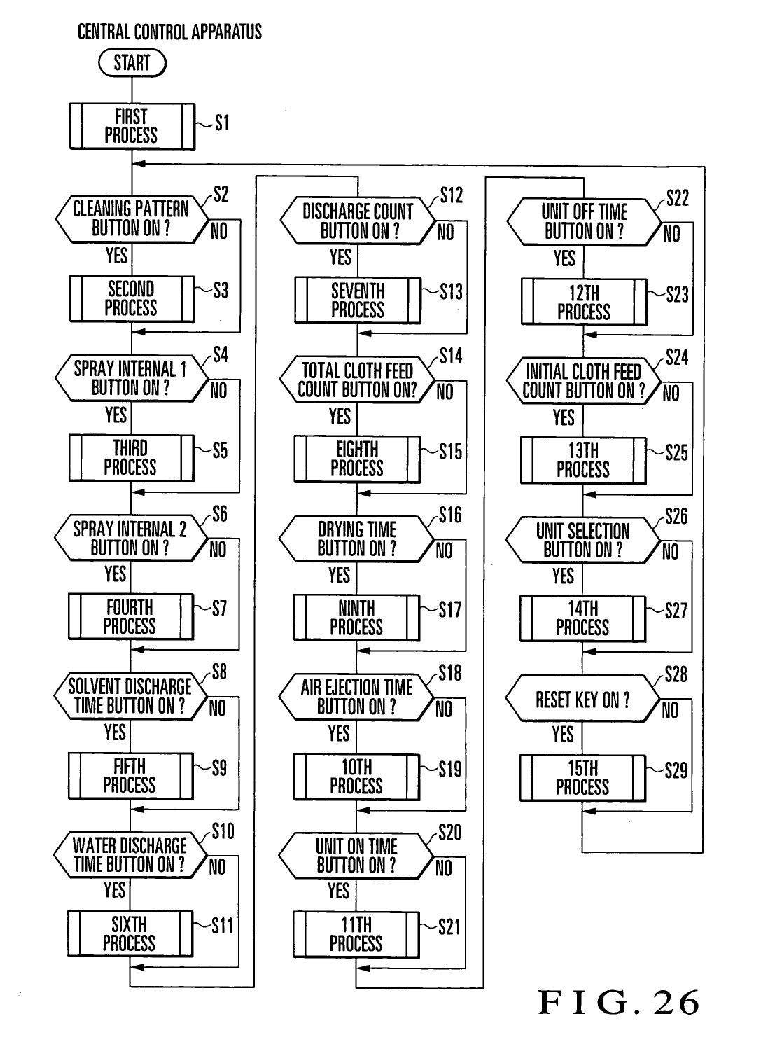

FIG. 26 shows a cleaning parameter change process executed by the CPU 8-1 of the central control apparatus 8.

[First Process: Display of Cleaning Parameter Change Operation Window]

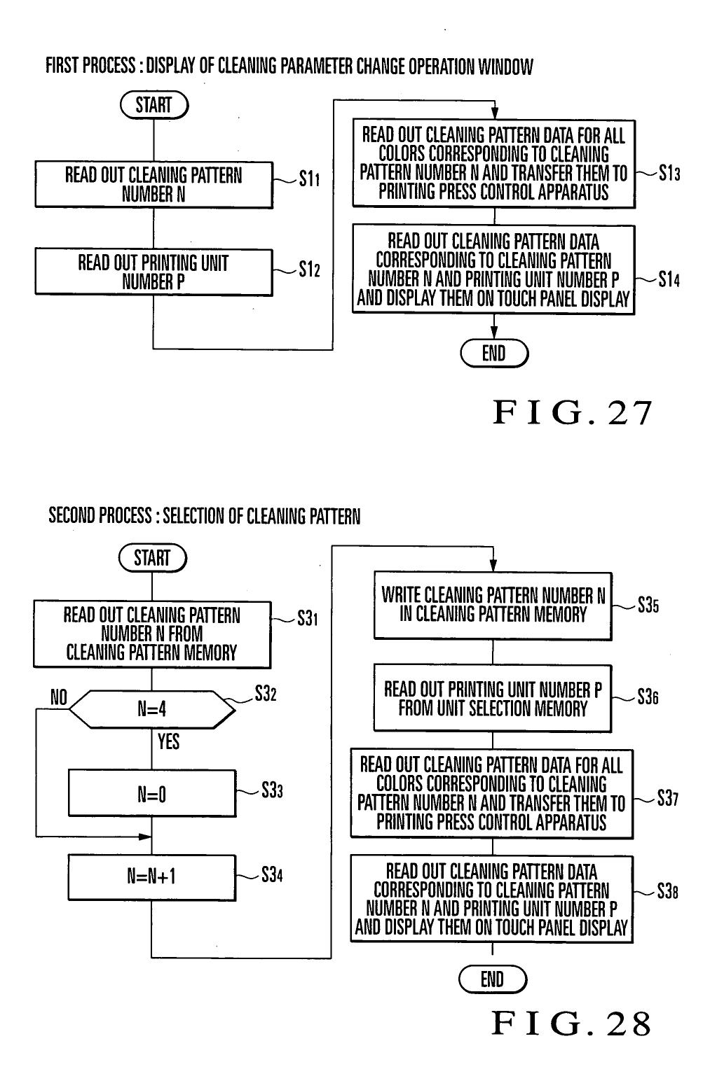

To display the cleaning parameter change operation window G1 shown in FIG. 25, the CPU 8-1 executes the first process (step S1). FIG. 27 shows the first process. In the first process, the CPU 8-1 reads out the cleaning pattern number N from the pattern number memory 8-5 (step S1₁). In this case, N=1 is read out. The CPU 8-1 reads out the printing unit number P from the unit selection memory 8-6 (step S1₂). In this case, P=1 is read out.

The CPU 8-1 specifies the pattern 1 data memory 8-13 as a pattern data memory corresponding to the cleaning pattern number N=1. The cleaning pattern data of cleaning pattern 1 for all colors are read out from the pattern 1 data memory 8-13 and transferred to the printing press control apparatus 7 (step S1₃). Accordingly, the cleaning pattern data of cleaning pattern 1 for all colors are stored in the cleaning pattern data memory 7-11 of the printing press control apparatus 7.

The CPU 8-1 specifies the pattern 1 data memory 8-13 as a pattern data memory corresponding to the cleaning pattern number N=1. The cleaning pattern data for the first-color printing unit which is specified by the printing unit number P=1 is read out from the pattern 1 data memory 8-13. Changeable cleaning parameters in the cleaning pattern data are displayed on the display 8-4 (step S1₄). Accordingly, the cleaning parameter change operation window G1 shown in FIG. 25, i.e., the change operation window for the cleaning parameters of cleaning pattern 1 of the first-color printing unit is displayed on the display 8-4.

[Second Process: Selection of Cleaning Pattern]

When the display portion 8a in the cleaning parameter change operation window G1 is touched (YES in step S2), the CPU 8-1 executes the second process (step S3). FIG. 28 shows the second process. In the second process, the CPU 8-1 reads out the cleaning pattern number N from the pattern number memory 8-5 (step S3₁). In this case, N=1 is read out. After it is confirmed that the readout cleaning pattern number N is N≠4 (NO in step S3₂), N is incremented by one to N=N+1 (step S3₄). In this case, N=1+1=2.

The CPU 8-1 writes the cleaning pattern number N=2 incremented in step S3₄ in the pattern number memory 8-5 as a preceding value (step S3₅) and reads out the printing unit number P from the unit selection memory 8-6 (step S3₆). In this case, P=1 is read out. The pattern 2 data memory 8-14 is specified as a pattern data memory corresponding to the cleaning pattern number N=2. The cleaning pattern data of cleaning pattern 2 for all colors are read out from the pattern 2 data memory 8-14 and transferred to the printing press control apparatus 7 (step S3₇). Accordingly, the cleaning pattern data of cleaning pattern 2 for all colors are stored in the cleaning pattern data memory 7-11 of the printing press control apparatus 7.

The CPU 8-1 specifies the pattern 2 data memory 8-14 as a pattern data memory corresponding to the cleaning pattern number N=2. The cleaning pattern data for the first-color printing unit which is specified by the printing unit number P=1 is read out from the pattern 2 data memory 8-14. Changeable cleaning parameters in the cleaning pattern data are displayed on the display 8-4 (step S3₈). Accordingly, the change operation window for the cleaning parameters of cleaning pattern 2 of the first-color printing unit is displayed on the display 8-4.

In the same way, every time the display portion 8a is touched, the cleaning pattern number N is incremented in step S3₄. Display of the cleaning pattern number N changes to “3” or “4”. The change operation window for the cleaning parameters of cleaning pattern 3 or 4 of the first-color printing unit is displayed. Accordingly, the operator can select a cleaning pattern appropriate for the cleaning conditions. When the count value of the cleaning pattern number N is N=4 in step S3₄, and YES in step S3₂, the flow advances to step S3₃ to set N=0. With this process, the cleaning parameter change operation window returns to the change operation window for cleaning pattern 1 of the first-color printing unit.

[Third Process: Change of Cloth Feed Count at Spray Interval 1]

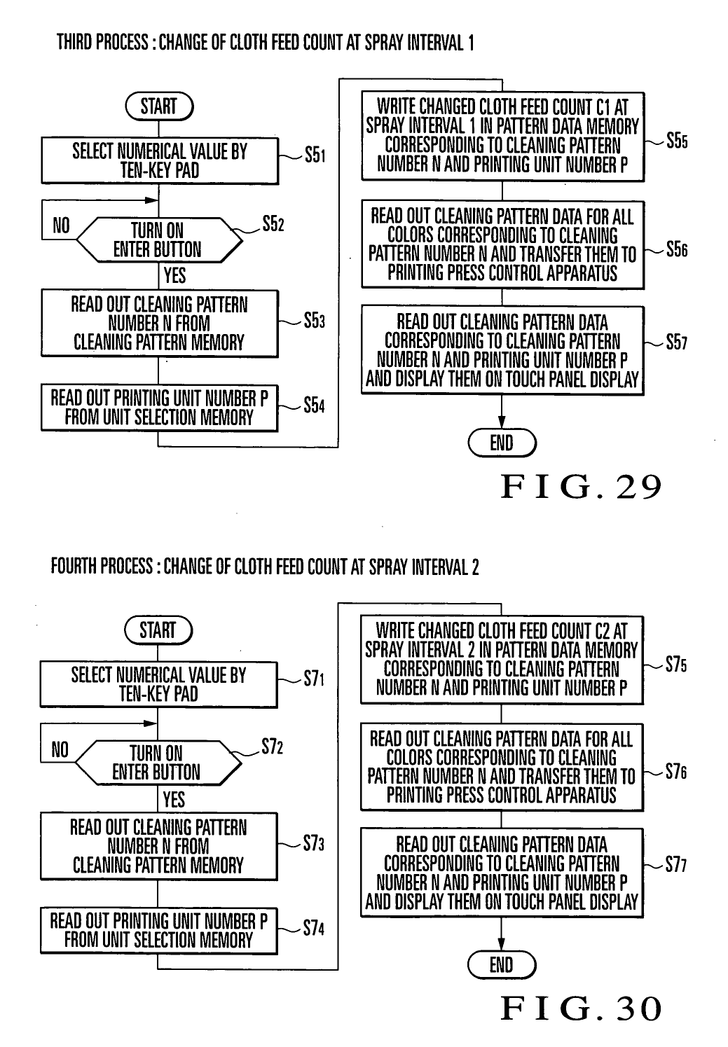

When the display portion 8b in the cleaning parameter change operation window G1 is touched (YES in step S4), the CPU 8-1 executes the third process (step S5). FIG. 29 shows the third process. In the third process, the user selects a desired value by the ten-key pad 8p (step S5₁) and touches the enter key 8q (step S5₂. For example, to change the cloth feed count C1 at spray interval 1 from 8 to 9, “9” is selected by the ten-key pad 8p, and the enter key 8q is touched.

The CPU 8-1 detects the pressed state of the enter key 8q after value selection by the ten-key pad 8p (YES in step S5₂) and reads out the cleaning pattern number N from the pattern number memory 8-5 (step S5₃). In this case, N=1 is read out. Next, the CPU 8-1 reads out the printing unit number P from the unit selection memory 8-6 (step S5₄). In this case, P=1 is read out.

The CPU 8-1 specifies the pattern 1 data memory 8-13 as a pattern data memory corresponding to the cleaning pattern number N=1. The cloth feed count C1 at spray interval 1 in cleaning pattern 1, which is written in the pattern 1 data memory 8-13 in correspondence with the first-color printing unit specified by the printing unit number P=1, is rewritten to the value selected in step S5₁ (step S5₅). The cleaning pattern data of cleaning pattern 1 for all colors are read out from the pattern 1 data memory 8-13 and transferred to the printing press control apparatus 7 (step S5₆). Accordingly, the cleaning pattern data of cleaning pattern 1 for all colors are stored in the cleaning pattern data memory 7-11 of the printing press control apparatus 7. In this case, the cloth feed count C1 at spray interval 1 of cleaning pattern 1 for the first-color printing unit has been rewritten to the value selected in step S5₁.

The CPU 8-1 specifies the pattern 1 data memory 8-13 as a pattern data memory corresponding to the cleaning pattern number N=1. The cleaning pattern data for the first-color printing unit which is specified by the printing unit number P=1 is read out from the pattern 1 data memory 8-13. Changeable cleaning parameters in the cleaning pattern data are displayed on the display 8-4 (step S5₇). Accordingly, the change operation window for the cleaning parameters of cleaning pattern 1 of the first-color printing unit is displayed on the display 8-4. In the change operation window, the cloth feed count C1 at spray interval 1 displayed in the display portion 8b is changed to the value selected in step S5₁.

[Fourth Process: Change of Cloth Feed Count at Spray Interval 2]

When the display portion 8c in the cleaning parameter change operation window G1 is touched (YES in step S6), the CPU 8-1 executes the fourth process (step S7). FIG. 30 shows the fourth process. By the fourth process, the cloth feed count C2 at spray interval 2 can be changed to a desired value as in the third process. In the fourth process, the process in steps S7₁ to S7₇ corresponds to the process in step S5₁ to S5₇ in the third process. In the fourth process, the changed cloth feed count C2 at spray interval 2 is written in the pattern 1 data memory 8-13 in step S7₅.

[Fifth Process: Change of Solvent Discharge Time]

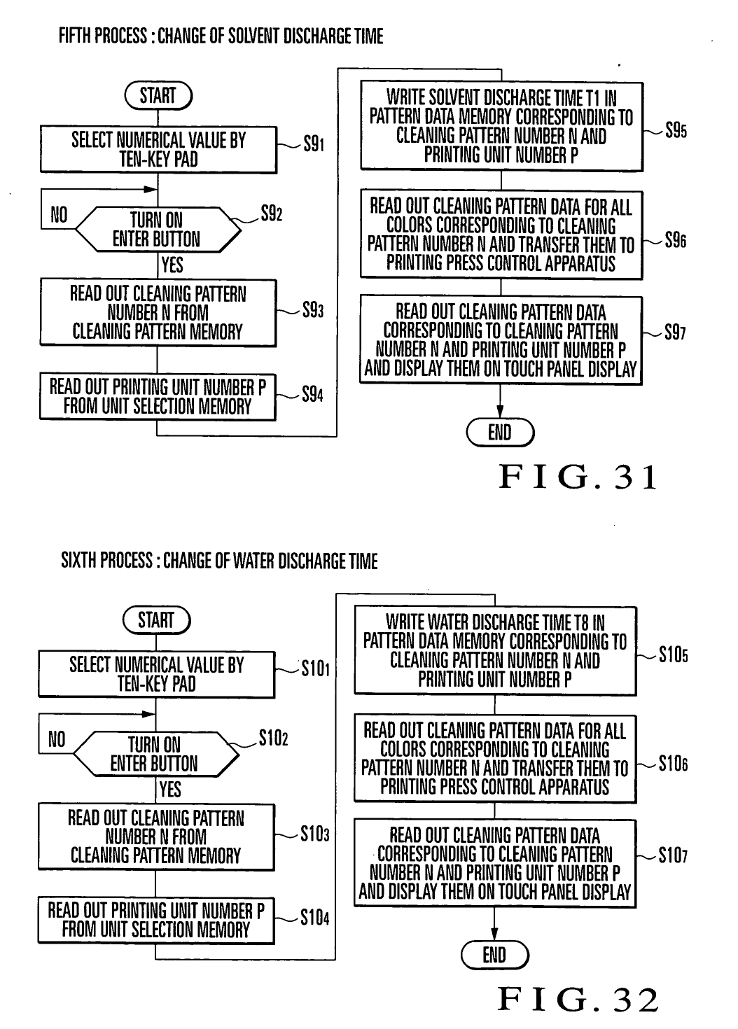

When the display portion 8f in the cleaning parameter change operation window G1 is touched (YES in step S8), the CPU 8-1 executes the fifth process (step S9). FIG. 31 shows the fifth process. By the fifth process, the solvent discharge time t1 can be changed to a desired value as in the third process. In the fifth process, the process in steps S9₁ to S9₇ corresponds to the process in step S5₁ to S5₇ in the third process. In the fifth process, the solvent discharge time t1 is written in the pattern 1 data memory 8-13 in step S9₅.

[Sixth Process: Change of Water Discharge Time]

When the display portion 8g in the cleaning parameter change operation window G1 is touched (YES in step S10), the CPU 8-1 executes the sixth process (step S11). FIG. 32 shows the sixth process. By the sixth process, the water discharge time t8 can be changed to a desired value as in the third process. In the sixth process, the process in steps S10₁ to S10₇ corresponds to the process in step S5₁ to S5₇ in the third process. In the sixth process, the water discharge time t8 is written in the pattern 1 data memory 8-13 in step S10₅.

[Seventh Process: Change of Discharge Count]

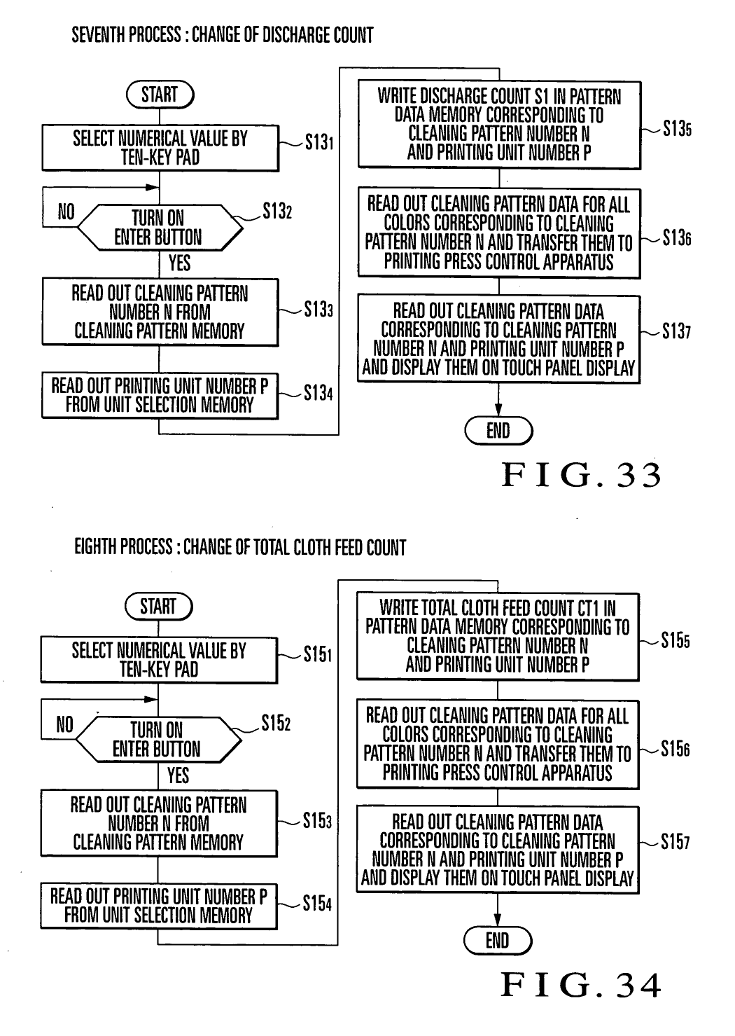

When the display portion 8h in the cleaning parameter change operation window G1 is touched (YES in step S12), the CPU 8-1 executes the seventh process (step S13). FIG. 33 shows the seventh process. By the seventh process, the discharge count S1 can be changed to a desired value as in the third process. In the seventh process, the process in steps S13₁ to S13₇ corresponds to the process in step S5₁ to S5₇ in the third process. In the seventh process, the discharge count S1 is written in the pattern 1 data memory 8-13 in step S13₅.

[Eighth Process: Change of Total Cloth Feed Count CT1]

When the display portion 8i in the cleaning parameter change operation window G1 is touched (YES in step S14), the CPU 8-1 executes the eighth process (step S15). FIG. 34 shows the eighth process. By the eighth process, the total cloth feed count CT1 can be changed to a desired value as in the third process. In the eighth process, the process in steps S151 to S15₁ corresponds to the process in step S5₁ to S5₇ in the third process. In the eighth process, the total cloth feed count CT1 is written in the pattern 1 data memory 8-13 in step S155.

[Ninth Process: Change of Drying Time]

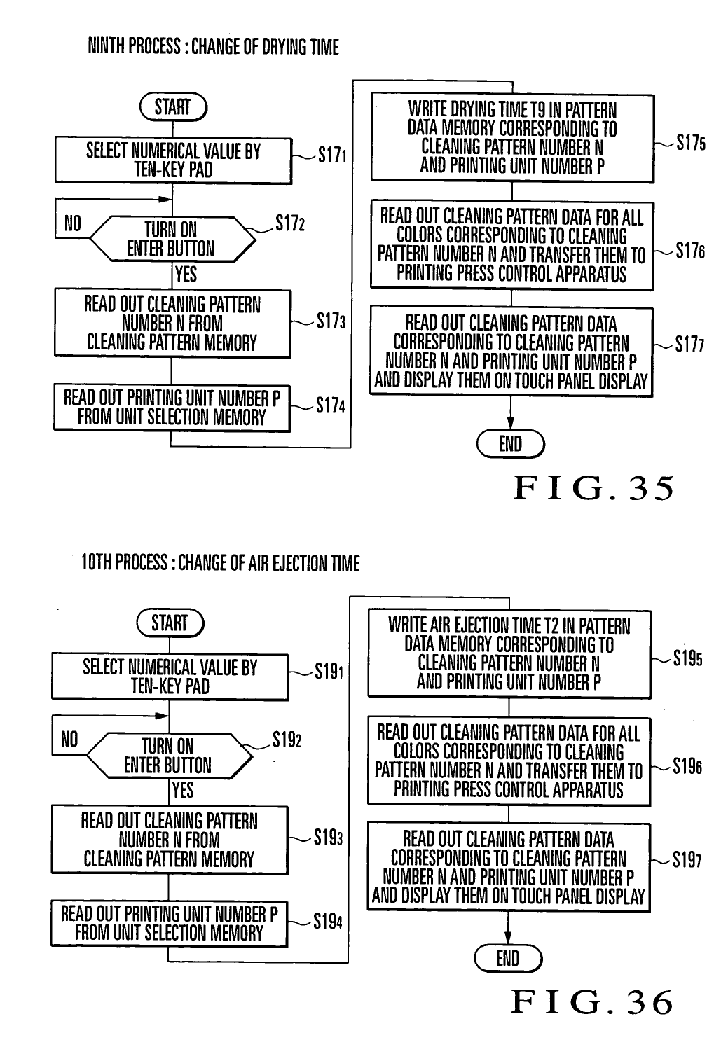

When the display portion 8j in the cleaning parameter change operation window G1 is touched (YES in step S16), the CPU 8-1 executes the ninth process (step S17). FIG. 35 shows the ninth process. By the ninth process, the drying time t9 can be changed to a desired value as in the third process. In the ninth process, the process in steps S17₁ to S17₇ corresponds to the process in step S5₁ to S5₇ in the third process. In the ninth process, the drying time t9 is written in the pattern 1 data memory 8-13 in step S17₅.

[10th Process: Change of Air Ejection Time]

When the display portion 8k in the cleaning parameter change operation window G1 is touched (YES in step S18), the CPU 8-1 executes the 10th process (step S19). FIG. 36 shows the 10th process. By the 10th process, the air ejection time t2 can be changed to a desired value as in the third process. In the 10th process, the process in steps S19₁ to S19₇ corresponds to the process in step S5₁ to S5₇ in the third process. In the 10th process, the air ejection time t2 is written in the pattern 1 data memory 8-13 in step S19.

[11th Process: Change of Unit ON Time]

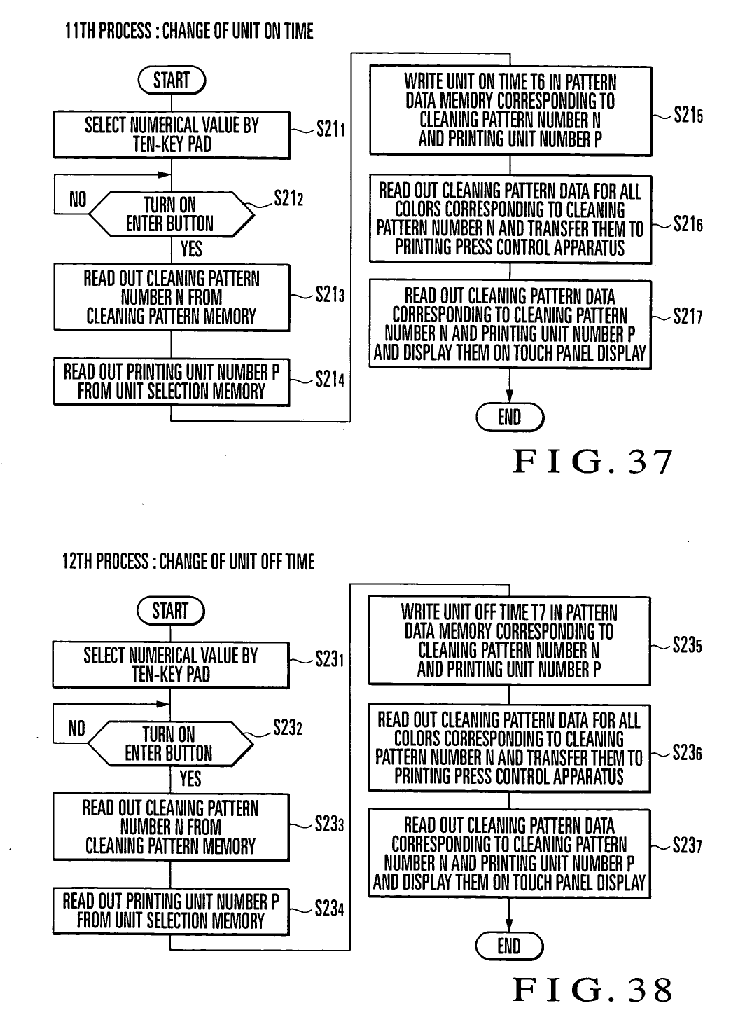

When the display portion 8e in the cleaning parameter change operation window G1 is touched (YES in step S20), the CPU 8-1 executes the 11th process (step S21). FIG. 37 shows the 11th process. By the 11th process, the unit ON time t6 can be changed to a desired value as in the third process. In the 11th process, the process in steps S21₁ to S21₇ corresponds to the process in step S5₁ to S5₇ in the third process. In the 11th process, the unit ON time t6 is written in the pattern 1 data memory 8-13 in step S21.

[12th Process: Change of Unit OFF Time]

When the display portion 8n in the cleaning parameter change operation window G1 is touched (YES in step S22), the CPU 8-1 executes the 12th process (step S23). FIG. 38 shows the 12th process. By the 12th process, the unit OFF time t7 can be changed to a desired value as in the third process. In the 12th process, the process in steps S23₁ to S23₇ corresponds to the process in step S5₁ to S5₇ in the third process. In the 12th process, the unit OFF time t7 is written in the pattern 1 data memory 8-13 in step S23₅.

[13th Process: Change of Initial Cloth Feed Count]

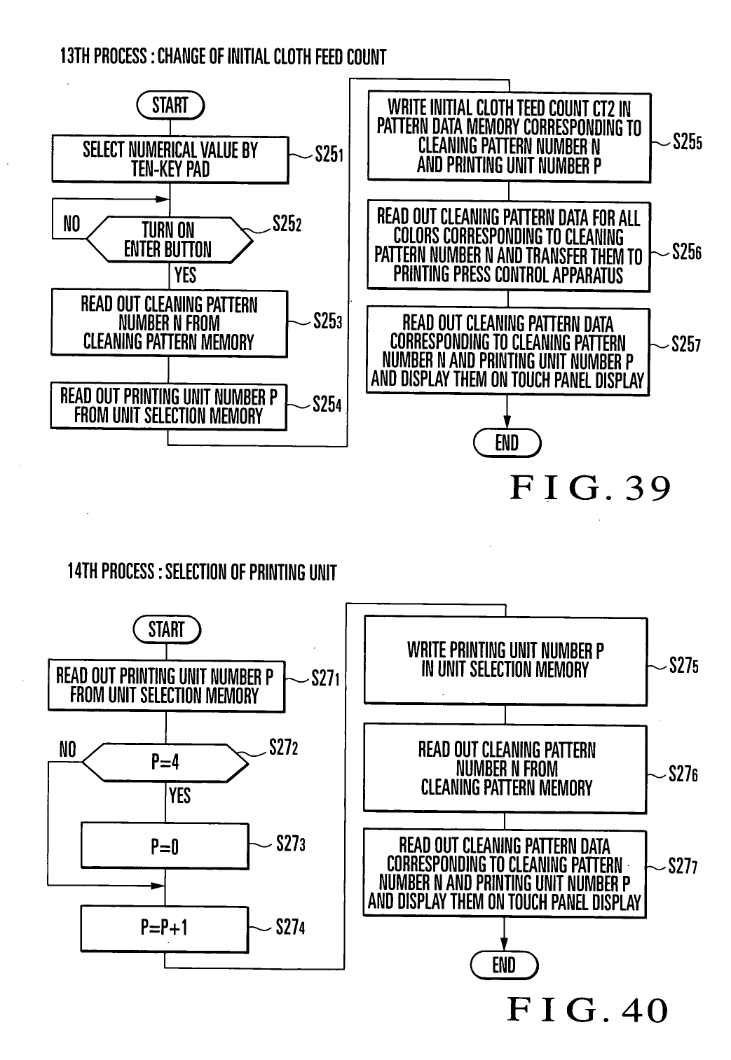

When the display portion 8d in the cleaning parameter change operation window G1 is touched (YES in step S24), the CPU 8-1 executes the 13th process (step S25). FIG. 39 shows the 13th process. By the 13th process, the initial cloth feed count CT2 can be changed to a desired value as in the third process. In the 13th process, the process in steps S25₁ to S25₇ corresponds to the process in step S5₁ to S5₇ in the third process. In the 13th process, the initial cloth feed count CT2 is written in the pattern 1 data memory 8-13 in step S25₅.

[14th Process: Selection of Printing Unit]

When the display portion 8m of the printing unit number P in the cleaning parameter change operation window G1 is touched (YES in step S26), the CPU 8-1 executes the 14th process (step S27). FIG. 40 shows the 14th process. In the 14th process, the CPU 8-1 reads out the printing unit number P from the unit selection memory 8-6 (step S27). In this case, P=1 is read out. After it is confirmed that the readout printing unit number P is P≠4 (NO in step S27₂), P is incremented by one to P=P+1 (step S27₄). In this case, P=1+1=2.

The CPU 8-1 writes the printing unit number P=2 incremented in step S27₄ in the unit selection memory 8-6 as a preceding value (step S27₅) and reads out the cleaning pattern number N from the pattern number memory 8-5 (step S27₆). In this case, N=1 is read out. The pattern 1 data memory 8-13 is specified as a pattern data memory corresponding to the cleaning pattern number N=1. The cleaning pattern data for the second-color printing unit specified by the printing unit number P=2 is read out from the pattern 1 data memory 8-13. Changeable cleaning parameters in the cleaning pattern data are displayed on the display 8-4 (step S277). Accordingly, the change operation window for the cleaning parameters of cleaning pattern 1 of the second-color printing unit is displayed on the display 8-4.

In the same way, every time the display portion 8m of the printing unit number P is touched, the printing unit number P is incremented in step S27₄. Display of the printing unit number P changes to “2”, “3”, or “4”. Cleaning pattern 1 of the third-color printing unit or cleaning pattern 1 of the fourth-color printing unit is displayed. When the count value of the printing unit number P is P=4 in step S27₄, and YES in step S27₂, the flow advances to step S27₃ to set P=0. With this process, the cleaning parameter change operation window returns to the change operation window for cleaning pattern 1 of the first-color printing unit.

[15th Process: Reset]

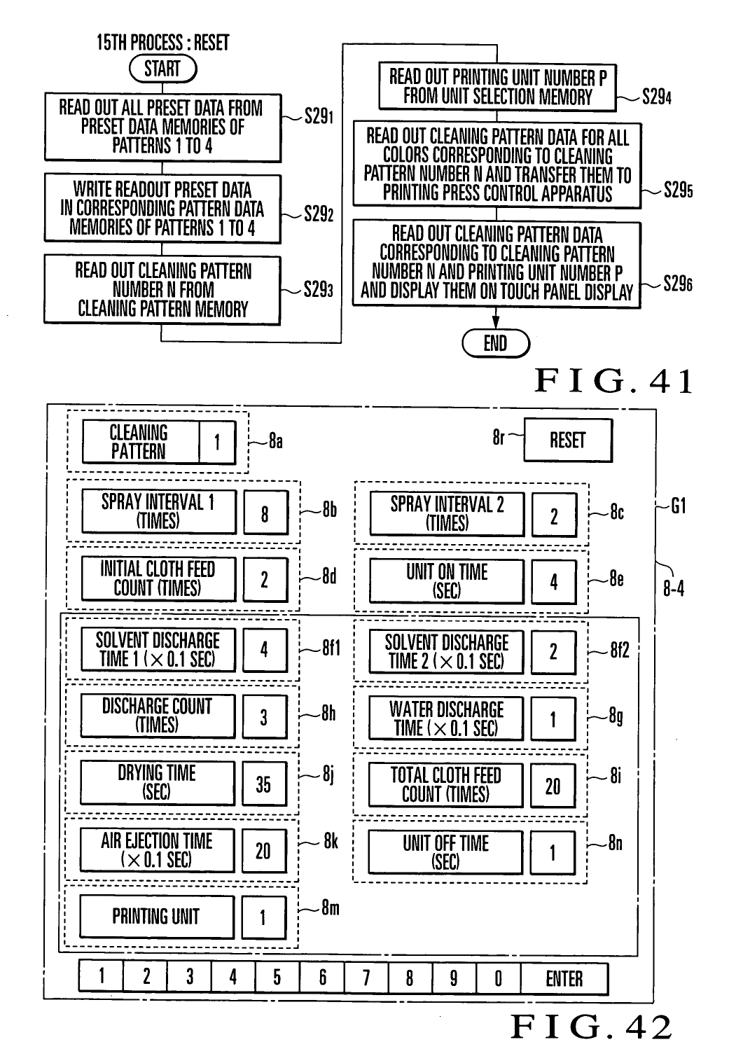

When the reset key 8r in the cleaning parameter change operation window G1 is touched (YES in step S28), the CPU 8-1 executes the 15th process (step S29). FIG. 41 shows the 15th process. In the 15th process, the CPU 8-1 reads out the preset data of cleaning patterns 1 to 4 (the default values of cleaning pattern data of cleaning patterns 1 to 4) for each color from the memories 8-9 to 8-12 (step S29₁).

The readout preset data of cleaning pattern 1 are overwritten in the pattern 1 data memory 8-13. The preset data of cleaning pattern 2 are overwritten in the pattern 2 data memory 8-14. The preset data of cleaning pattern 3 are overwritten in the pattern 3 data memory 8-15. The preset data of cleaning pattern 4 are overwritten in the pattern 4 data memory 8-16.

The cleaning pattern number N is read out from the pattern number memory 8-5 (step S29₃). In this case, N=1 is read out. Next, the printing unit number P is red out from the unit selection memory 8-6 (step S294). In this case, P=1 is read out. The pattern 1 data memory 8-13 is specified as a pattern data memory corresponding to the cleaning pattern number N=1. The cleaning pattern data of cleaning pattern 1 for all colors are read out from the pattern 1 data memory 8-13 and transferred to the printing press control apparatus 7 (step S29₅). Accordingly, the cleaning pattern data (default values) of cleaning pattern 1 for all colors are stored in the cleaning pattern data memory 7-11 of the printing press control apparatus 7.

The CPU 8-1 specifies the pattern 1 data memory 8-13 as a pattern data memory corresponding to the cleaning pattern number N=1. The cleaning pattern data for the first-color printing unit which is specified by the printing unit number P=1 is read out from the pattern 1 data memory 8-13. Changeable cleaning parameters in the cleaning pattern data are displayed on the display 8-4 (step S29₆). Accordingly, the change operation window for the cleaning parameters of cleaning pattern 1 of the first-color printing unit is displayed on the display 8-4. The default values of the cleaning parameters are displayed on the cleaning parameter change operation window.

As is apparent from the above description, in this embodiment, the printing unit and cleaning pattern are specified in the cleaning parameter change operation window displayed on the display 8-4. Then, the cleaning parameters such as the cloth feed count C1 at spray interval 1, cloth feed count C2 at spray interval 2, initial cloth feed count CT2, unit ON time t6, solvent discharge time t1, water discharge time t8, discharge count S1, total cloth feed count CT1, drying time t9, air ejection time t2, and unit OFF time t7 can appropriately be changed by the operator in accordance with the cleaning conditions.

In this embodiment, the cloth feed count C1 at spray interval 1, cloth feed count C2 at spray interval 2, total cloth feed count CT1, unit ON time t6, and unit OFF time t7 are conditions related to contact of the cleaning cloth 6i which is brought into contact with the blanket cylinder to clean it. In the conditions related to the contact, the cloth feed counts C1, C2, and CT1 equal to the number of times of ON/OFF of the cleaning cloth 6i with respect to the blanket cylinder 5. Strictly speaking, the unit ON time t6 includes the time until the cleaning cloth 6i comes into contact with the blanket cylinder 5. However, the unit ON time t6 almost equals the time of one contact of the cleaning cloth 6i to the blanket cylinder 5. In addition, the use amount of the cleaning cloth 6i used for cleaning of the blanket cylinder 5 can be known from the total cloth feed count CT1.

The discharge count S1 indicates the number of times of discharge of a cleaning solution to be supplied in cleaning the blanket cylinder 5. That is, the discharge count S1 indicates the number of times of discharge of the solvent or water. In this example, the solvent and water are individually discharged. Instead, a liquid (solvent+water) in which the solvent and water are mixed may be used. In this embodiment, “cleaning solution” is a superordinate concept including “solvent”, “water”, and “solvent+water”. The solvent supply amount can be known from the solvent discharge time t1. The water supply amount can be known from the water discharge time t8.

The cloth feed count C1 at spray interval 1, cloth feed count C2 at spray interval 2, and unit ON time t6 and unit OFF time t7 at spray interval 1 or 2 are conditions related to contact of the cleaning cloth 6i which is brought into contact with the blanket cylinder between successive cleaning solution supply operations which are intermittently executed a plurality of number of times in cleaning the blanket cylinder 5 (during interruption of cleaning solution supply operation). In the conditions related to the contact, the cloth feed counts C1 and C2 equal to the number of times of ON/OFF of the cleaning cloth 6i with respect to the blanket cylinder 5 between successive cleaning solution supply operations which are intermittently executed a plurality of number of times in cleaning the blanket cylinder 5. In addition, the unit ON time t6 almost equals the time of one contact of the cleaning cloth 6i to the blanket cylinder 5 between successive cleaning solution supply operations which are intermittently executed a plurality of number of times in cleaning the blanket cylinder 5.

The drying time t9 indicates a drying time in which the blanket cylinder 5 with the cleaning solution is rotated at a higher speed than during cleaning and dried. The initial cloth feed count CT2 indicates the feed amount of the cleaning cloth 6i during a time after the cleaning solution is supplied to the cleaning cloth 6i until the cleaning cloth is brought into contact with the blanket cylinder 5 in cleaning it.

In this embodiment, the display means for displaying the cleaning parameters includes the CPU 8-1 and display 8-4 of the central control apparatus 8 as main constituent elements and is implemented by a cooperative function of hardware and software which display the cleaning parameter change operation window.

The change means for changing the cleaning parameters includes the CPU 8-1 and display 8-4 of the central control apparatus 8 as main constituent elements and is implemented by a cooperative function of hardware and software which change the cleaning parameters transferred to the printing press control apparatus 7 in accordance with a user operation from the cleaning parameter change operation window.

The cleaning means for executing cleaning on the basis of the changed cleaning parameters includes the CPU 7-1 of the printing press control apparatus 7 and the cleaning apparatus 6 and is implemented by a cooperative function of hardware and software which execute cleaning of the blanket cylinder 5 by using the cleaning apparatus 6 on the basis of the rewritten cleaning pattern data.

In the above-described embodiment, when the cleaning solution is intermittently discharged a plurality of number of times, the solvent discharge time (solvent discharge amount) t1 for discharge of the cleaning solution is common. Instead, the user may arbitrarily set the solvent discharge time t1 for the first discharge and the solvent discharge time t1 from the second discharge. For example, in the timing chart of cleaning pattern 1 shown in FIG. 8, the first solvent discharge time t1 (=t11) at the time T1 and the second solvent discharge time t1 (=t12) at the time T3 may be different.

In the timing chart of cleaning pattern 4 shown in FIG. 11, the first solvent discharge time t1 (=t11) at the time T1, the second solvent discharge time t1 (=t12) at the time T3, and the third solvent discharge time t1 (=t12) at the time T5 may be different.

Generally, when the first solvent discharge is executed, the wiping by the cleaning cloth is done, the blanket cylinder considerably becomes clean. Hence, the solvent discharge amount from the second time can be smaller than in the first time. When the solvent discharge amount from the second time is decreased, the solvent and cleaning cloth can be saved. More specifically, the solvent discharge time from the second time is preferably set to about ⅔ that in the first time.

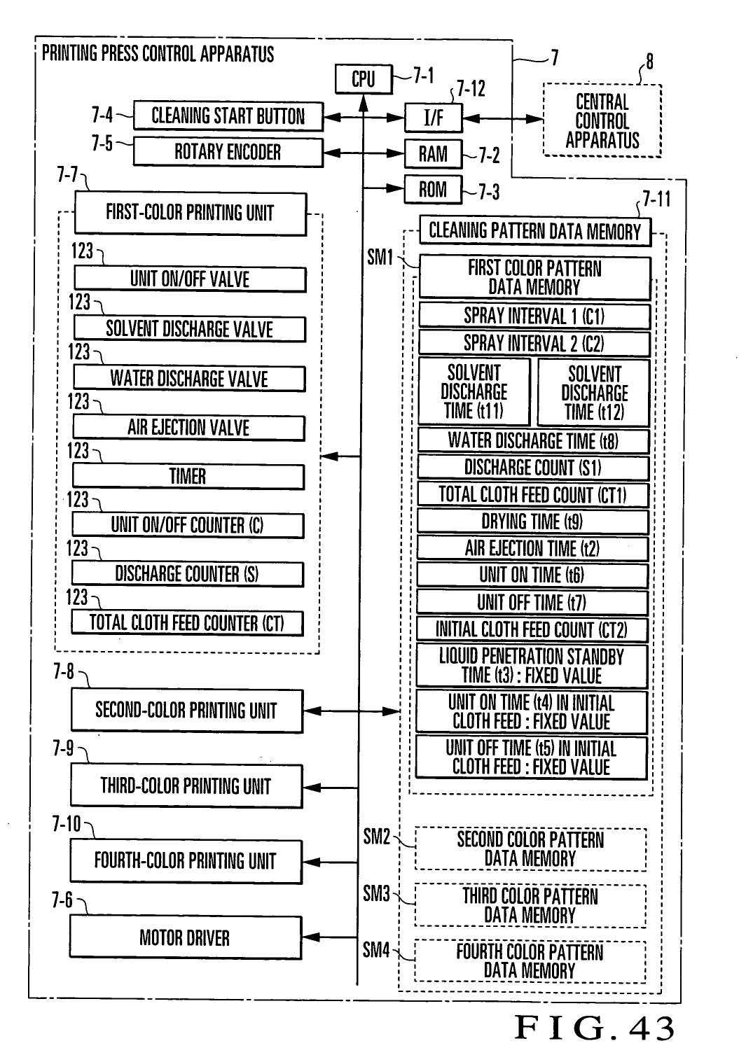

In this case, as shown in FIG. 42, a display portion 8f1 of the solvent discharge time t11 for the first time and a display portion 8f2 of the solvent discharge time t12 from the second time are prepared in the cleaning parameter change operation window displayed on the display 8-4. In the display portion 8f1, the solvent discharge time t11 for the first time can be changed. In the display portion 8f2, the solvent discharge time t12 for the second time can be changed. FIG. 43 shows the arrangement of the printing press control apparatus 7 which allows setting of different times as the solvent discharge time t11 for the first time and the solvent discharge time t12 from the second time. In this case, the solvent discharge time t11 for the first time and solvent discharge time t12 for the second time are added as cleaning parameters to the pattern data memories SM1 to SM4 in the cleaning pattern data memory 7-11.

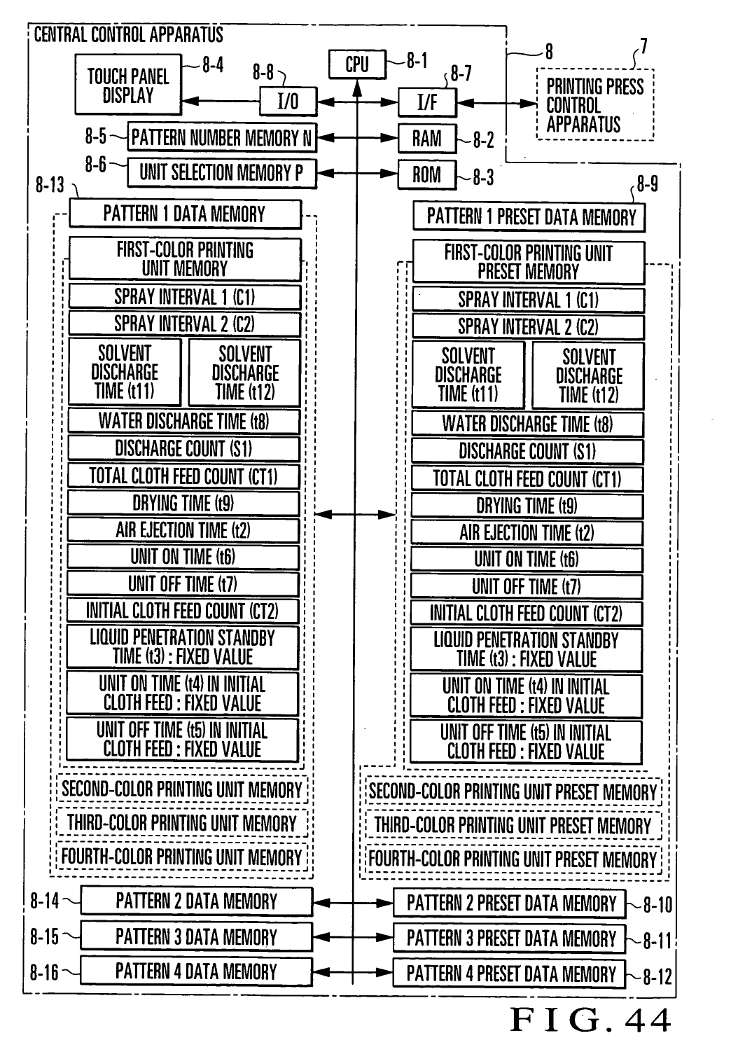

FIG. 44 shows the arrangement of the central control apparatus 8 which allows setting of different times as the solvent discharge time t11 for the first time and the solvent discharge time t12 from the second time. In this case, the solvent discharge time t11 for the first time and solvent discharge time t12 for the second time are added as cleaning parameters to the preset data of each color in the preset data memories 8-9 to 8-12. In addition, the solvent discharge time t11 for the first time and solvent discharge time t12 for the second time are added as cleaning parameters to the cleaning pattern data of each color in the pattern data memories 8-13 to 8-16.

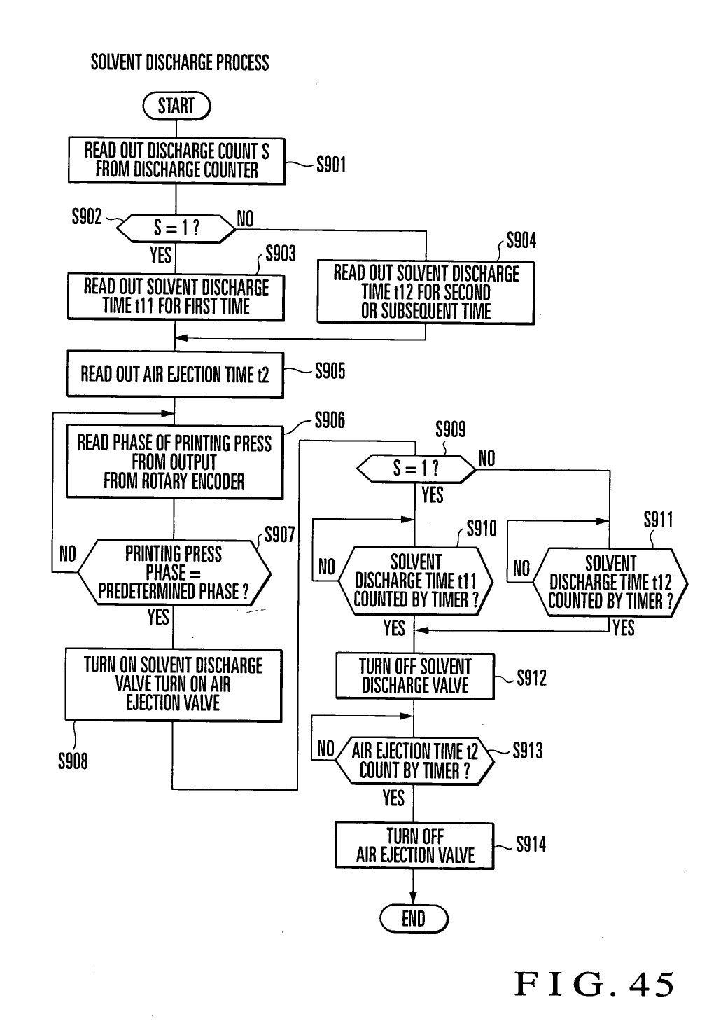

FIG. 45 shows “solvent discharge process” executed by the printing press control apparatus 7 when different times can be set as solvent discharge time t11 for the first time and solvent discharge time t12 from the second time. In this case, when the discharge count S counted by the discharge counter CNT2 is S=1 (YES in step S902), the solvent discharge time t11 for the first time is read out from the pattern data memory SM (SM1 to SM4) of the cleaning pattern data memory 7-11 (step S903). If the discharge count S counted by the discharge counter CNT2 is S≠1 (NO in step S902), the solvent discharge time t12 for the second or subsequent time is read out from the pattern data memory SM (SM1 to SM4) of the cleaning pattern data memory 7-11 (step S904).

When the discharge count S counted by the discharge counter CNT2 is S=1 (YES in step S909), the solvent discharge valve V2 is turned off after the elapse of the solvent discharge time t11 for the first time (step S912). If the discharge count S counted by the discharge counter CNT2 is S≠1 (NO in step S909), the solvent discharge valve V2 is turned off after the elapse of solvent discharge time t12 for the second or subsequent time (step S912).

In this embodiment, step S1 in FIG. 26 corresponds to the display step in the present invention. Steps S2 to S29 in FIG. 26 correspond to the change step in the present invention. The operation step of the printing press control apparatus 7 shown in FIGS. 16 to 23 corresponds to the cleaning step in the present invention. The change step includes not only the step of changing the individual cleaning parameters, as in steps S4 to S24, but also the step of switching the cleaning pattern as in steps S2 and S3 and the step of returning a changed cleaning parameter to a default value as in steps S28 and S29.

In this embodiment, the names and values of the cleaning parameters are displayed on the touch panel display 8-4 serving as the display means. For this reason, the operator can easily recognize the current cleaning parameter values. The operator can not only easily determine a change value but also easily select a cleaning parameter to be changed. As a result, the change operation can easily be done.

According to the present invention, conditions related to contact of a cleaning web to a rotary member are displayed as cleaning parameters. When the displayed conditions related to contact of the cleaning web to the rotary member are changed, cleaning of the rotary member is executed on the basis of the changed cleaning parameters. The conditions related to contact of the cleaning web to the rotary member include the time of contact of the cleaning web to the rotary member and the number of times of ON/OFF of the cleaning web with respect to the rotary member. Changeable cleaning parameters may be conditions (e.g., the contact time and the number of times of ON/OFF) related to contact of the cleaning web which is brought into contact with the rotary member between successive cleaning solution supply operations which are intermittently executed a plurality of number of times in cleaning the rotary member.

The changeable cleaning parameters are not limited to the conditions related to contact of the cleaning web. They may be the number of times of supply of the cleaning solution to be supplied to clean the rotary member, the use amount of the cleaning web to be used to clean the rotary member, and the supply amount of the cleaning solution to be supplied to clean the rotary member.

The changeable cleaning parameters may be the drying time in which the rotary member with the cleaning solution is rotated after cleaning at a higher speed than during cleaning and dried, the feed amount of the cleaning web during a time after the cleaning solution is supplied to the cleaning web until the cleaning web is brought into contact with the rotary member in cleaning it, and the supply amount for the first time and that from the second time of the cleaning solution which is intermittently supplied a plurality of number of times in cleaning the rotary member.

In the present invention, “cleaning solution” includes “solvent”, “water”, and “solution mixture of a solvent and water”. The cleaning web includes a cloth and paper. In the above-described embodiment, a cleaning web is used as a cleaning member. Not the cleaning web but a scraper or brush may be used. In the above-described embodiment, the cleaning solution is supplied to the circumferential surface of the blanket cylinder through the cleaning web. The cleaning solution may be discharged to the circumferential surface of the blanket cylinder directly from the valve. The present invention can also be constituted as an apparatus which applies the above-described method.

As described above, according to the present invention, changeable cleaning parameters are displayed. By changing the displayed cleaning parameters, cleaning of the rotary member is executed on the basis of the changed cleaning parameters. Since the operator can appropriately change the cleaning parameters, the cleaning work can be executed on the basis of optimum conditions including the cleaning web contact time and cleaning solution supply amount.

1. A printing press cleaning method of cleaning a circumferential surface of a rotary member on the basis of a cleaning parameter, comprising the steps of:
displaying the cleaning parameter;
changing the displayed cleaning parameter; and
cleaning the rotary member on the basis of the changed cleaning parameter,
wherein the cleaning parameter includes at least one of values related to a cleaning member which comes into contact with the rotary member, a cleaning solution which is supplied to the rotary member, and the rotary member.

2. A method according to claim 1, wherein the cleaning member is a cleaning web which comes into contact with the circumferential surface of the rotary member.

3. A method according to claim 2, wherein the cleaning parameter includes a condition related to contact of the cleaning web to the rotary member.

4. A method according to claim 3, wherein the condition related to contact includes a time of contact of the cleaning web to the rotary member.

5. A method according to claim 3, wherein the condition related to contact includes the number of times of contact ON/OFF operation of the cleaning web with respect to the rotary member.

6. A method according to claim 1, wherein the cleaning parameter includes the number of times of supply of the cleaning solution to be supplied to the rotary member.

7. A method according to claim 2, wherein the cleaning parameter includes a condition related to contact of the cleaning web to the rotary member between successive supply operations of the cleaning solution, which are intermittently executed a plurality of number of times.

8. A method according to claim 7, wherein the condition related to contact includes a time of contact of the cleaning web to the rotary member.

9. A method according to claim 8, wherein the condition related to contact includes the number of times of contact ON/OFF operation of the cleaning web with respect to the rotary member.

10. A method according to claim 2, wherein the cleaning parameter includes a use amount of the cleaning web used in cleaning the rotary member.

11. A method according to claim 1, wherein the cleaning parameter includes a supply amount of the cleaning solution supplied in cleaning the rotary member.

12. A method according to claim 1, wherein the cleaning parameter includes a drying time in which, after cleaning of the rotary member, the rotary member with the cleaning solution is rotated at a higher speed than during cleaning and dried.

13. A method according to claim 2, wherein the cleaning parameter includes a feed amount of the cleaning web during a time after the cleaning solution is supplied to the cleaning cloth until the cleaning cloth is brought into contact with the rotary member in cleaning the rotary member.

14. A method according to claim 1, wherein the cleaning parameter includes a supply amount for first time and a supply amount from second time of the cleaning solution which is intermittently supplied a plurality of number of times.

15. A printing press cleaning apparatus for cleaning a circumferential surface of a rotary member on the basis of a cleaning parameter, comprising:
display means for displaying the cleaning parameter;
change means for changing the displayed cleaning parameter; and
cleaning means for cleaning the rotary member on the basis of the changed cleaning parameter,
wherein the cleaning parameter includes at least one of values related to a cleaning member which comes into contact with the rotary member, a cleaning solution which is supplied to the rotary member, and the rotary member.

16. An apparatus according to claim 15, wherein the cleaning member is a cleaning web which comes into contact with the circumferential surface of the rotary member.

17. An apparatus according to claim 16, wherein the cleaning parameter includes a condition related to contact of the cleaning web to the rotary member.

18. An apparatus according to claim 17, wherein the condition related to contact includes a time of contact of the cleaning web to the rotary member.

19. An apparatus according to claim 17, wherein the condition related to contact includes the number of times of contact ON/OFF operation of the cleaning web with respect to the rotary member.

20. An apparatus according to claim 16, wherein the cleaning parameter includes the number of times of supply of the cleaning solution to be supplied to the rotary member.

21. An apparatus according to claim 16, wherein the cleaning parameter includes a condition related to contact of the cleaning web to the rotary member between successive supply operations of the cleaning solution, which are intermittently executed a plurality of number of times.

22. An apparatus according to claim 21, wherein the condition related to contact includes a time of contact of the cleaning web to the rotary member.

23 An apparatus according to claim 21, wherein the condition related to contact includes the number of times of contact ON/OFF operation of the cleaning web with respect to the rotary member.

24. An apparatus according to claim 16, wherein the cleaning parameter includes a use amount of the cleaning web used in cleaning the rotary member.

25. An apparatus according to claim 15, wherein the cleaning parameter includes a supply amount of the cleaning solution supplied in cleaning the rotary member.

26. An apparatus according to claim 15, wherein the cleaning parameter includes a drying time in which, after cleaning of the rotary member, the rotary member with the cleaning solution is rotated at a higher speed than during cleaning and dried.

27. An apparatus according to claim 16, wherein the cleaning parameter includes a feed amount of the cleaning web during a time after the cleaning solution is supplied to the cleaning cloth until the cleaning cloth is brought into contact with the rotary member in cleaning the rotary member.

28. An apparatus according to claim 15, wherein the cleaning parameter includes a supply amount for first time and a supply amount from second time of the cleaning solution which is intermittently supplied a plurality of number of times.
